(19) United States
(12) Patent Application Publication
(10) Pub. No.: US 2013/0084108 A1
(43) Pub. Date: Apr. 4, 2013

(54) DEVELOPMENT DEVICE AND IMAGE FORMING APPARATUS INCLUDING THE SAME

(71) Applicants: Shiro SUZUKI, Kanagawa (JP); Yoshifumi OZAKI, Kanagawa (JP); Akihiko NODA, Kanagawa (JP)

(72) Inventors: Shiro SUZUKI, Kanagawa (JP); Yoshifumi OZAKI, Kanagawa (JP); Akihiko NODA, Kanagawa (JP)

(73) Assignee: FUJI XEROX CO., LTD., Tokyo (JP)

(21) Appl. No.: 13/458,551

(22) Filed: Apr. 27, 2012

(30) Foreign Application Priority Data
Oct. 4, 2011 (JP) 2011-220426

(51) Int. Cl. G03G 15/09

(52) U.S. Cl. 399/274

(57) ABSTRACT

A development device includes a developer carrier; a layer-regulating rotating member that faces the developer carrier with a gap therebetween and rotates in a direction following the rotation of the developer carrier while regulating the thickness of a layer of developer on the developer carrier; a development controller that controls, during development, the developer carrier and the layer-regulating rotating member to rotate at respective predetermined speeds and develops an electrostatic latent image on an image carrier with the developer; and a discharge controller that controls, while development is stopped, the developer carrier to rotate at a predetermined speed while controlling the layer-regulating rotating member to rotate at a speed that changes intermittently such that the amount of developer passing the layer-regulating rotating member changes and any foreign matter and aggregates in the developer are discharged together with the layer of the developer whose thickness is changed on the developer carrier.

### CROSS-REFERENCE TO RELATED APPLICATIONS

This application is based on and claims priority under 35 USC 119 from Japanese Patent Application No. 2011-220426 filed Oct. 4, 2011.

### BACKGROUND

### (i) Technical Field

The present invention relates to a development device and an image forming apparatus including the same.

### SUMMARY

According to an aspect of the invention, there is provided a development device including a developer carrier that faces an image carrier capable of carrying an electrostatic latent image and is configured to rotate while carrying developer that contains at least a toner and to develop the electrostatic latent image on the image carrier with the toner; a layer-regulating rotating member that faces the developer carrier with a predetermined gap interposed therebetween and is configured to rotate in a direction that follows the rotation of the developer carrier in such a manner as to regulate the thickness of a layer of the developer on the developer carrier; a development controller that controls, when development is performed, the developer carrier and the layer-regulating rotating member to rotate at respective predetermined circumferential speeds and supplies the developer on the developer carrier to the electrostatic latent image on the image carrier; and a discharge controller that controls, at a certain time while development is stopped, the developer carrier to rotate at a predetermined circumferential speed while controlling the layer-regulating rotating member to rotate at a circumferential speed that changes intermittently such that the amount of developer passing the layer-regulating rotating member increases and decreases and any pieces of foreign matter and aggregates that are present in the developer are discharged together with the layer of the developer whose thickness is increased and decreased on the developer carrier.

### BRIEF DESCRIPTION OF THE DRAWINGS

Exemplary embodiments of the present invention will be described in detail based on the following figures, wherein:

FIG. 1 illustrates an outline of an image forming apparatus to which exemplary embodiments of the present invention are applied;

FIG. 2A schematically illustrates how developer that is present near a layer-regulating rotating member is transported in a development device included in the image forming apparatus illustrated in FIG. 1 when the circumferential speed of the layer-regulating rotating member is changed while development is performed;

FIGS. 2B to 2D schematically illustrate exemplary embodiments of an operation of controlling the discharge of foreign matter and aggregates from the development device illustrated in FIG. 1 performed while development is stopped;

FIGS. 3A and 3B schematically illustrate exemplary embodiments of an operation of controlling the collection of foreign matter and aggregates performed in the image forming apparatus illustrated in FIG. 1 while development is stopped;

FIG. 4 illustrates an overall configuration of an image forming apparatus according to a specific exemplary embodiment;

FIG. 5A illustrates a layout of a development roller and a rotating trimmer included in a development device according to the specific exemplary embodiment;

FIG. 5B illustrates an exemplary magnetic-flux-density distribution produced by magnetic poles of a magnetic roller included in the development roller;

FIG. 6A illustrates transmission Mechanisms included in the development device;

FIG. 6B schematically illustrates how the transmission mechanisms are driven;

FIG. 7 illustrates a drive control mechanism included in the development device;

FIG. 8 is a flowchart illustrating an exemplary operation of controlling the amount of mass on the sleeve (MOS) on the basis of image information that is employed in a drive control mechanism included in the development device according to the specific exemplary embodiment;

FIG. 9 is a flowchart illustrating an exemplary operation of controlling the amount of MOS on the basis of usage history information that is employed in the drive control mechanism included in the development device according to the specific exemplary embodiment;

FIG. 10 is a flowchart illustrating an exemplary operation of controlling the amount of MOS on the basis of environmental information that is employed in the drive control mechanism included in the development device according to the specific exemplary embodiment;

FIG. 11A illustrates changes in the amount of MOS occurring with changes in the circumferential speed of the rotating trimmer included in the development device according to the specific exemplary embodiment;

FIG. 11B is a graph illustrating the amount of MOS versus the circumferential speed ratio of the rotating trimmer;

FIGS. 12A to 12C illustrate how the amount of MOS changes with the circumferential speed, denoted by v, of the rotating trimmer included in the development device according to the specific exemplary embodiment in cases where vᵣ=vᵣ₁, vᵣ=vᵣ₂≠vᵣ₁, and vᵣ=0 (or <0), respectively;

FIG. 13 is a flowchart illustrating an exemplary operation of controlling the discharge and collection of foreign matter and aggregates that is employed by the drive control mechanism included in the development device illustrated in FIG. 7;

FIG. 14A illustrates an exemplary operation of detecting any defects related to foreign matter and aggregates on the basis of information on an image formed on a recording material;

FIG. 14B illustrates an exemplary operation of detecting any defects related to foreign matter and aggregates from a layer of the developer formed in the development device;

FIGS. 15A to 15C schematically illustrate how the developer that is present near the rotating trimmer behaves in a first exemplary embodiment of a discharge mode according to the specific exemplary embodiment;

FIGS. 16A to 16C schematically illustrate how the developer that is present near the rotating trimmer behaves in a second exemplary embodiment of the discharge mode according to the specific exemplary embodiment;

FIGS. 17A and 17B schematically illustrate how the developer that is present near the rotating trimmer behaves in a third exemplary embodiment of the discharge mode according to the specific exemplary embodiment;

FIG. 18A schematically illustrate how the developer that is present near the rotating trimmer behaves in a fourth exemplary embodiment of the discharge mode according to the specific exemplary embodiment;

FIG. 18B illustrates the state of the surface of the rotating trimmer illustrated in FIG. 18A;

FIG. 19 illustrates a first exemplary embodiment of a collection mode according to the specific exemplary embodiment;

FIG. 20 illustrates a second exemplary embodiment of the collection mode according to the specific exemplary embodiment;

FIG. 21A illustrates a development device according to Examples (Examples 1-1 and 1-2);

FIG. 21B illustrates a development device according to Comparative Examples (Comparative Examples 1 and 2);

FIG. 22A illustrates the surface of a development sleeve (a smooth sleeve) employed in Examples;

FIG. 22B illustrates the surface of a development sleeve (a blast sleeve) employed in Comparative Example 1;

FIG. 22C illustrates the surface of a development sleeve (a grooved, sleeve) employed in Comparative Example 2;

FIG. 23 is a table summarizing the state of MOS in different combinations of the trimmer, the magnetic flux density of a layer-regulation magnetic pole, and the surface of the development sleeve observed in tests conducted for evaluating how the developer is transported in the development devices according to Examples and Comparative Examples; and

FIG. 24 is a graph illustrating the amount of MOS versus the circumferential speed ratio of the rotating trimmer in the development devices according to Examples 1-1, 1-2, and 2.

### DETAILED DESCRIPTION

### Outline of Exemplary Embodiments

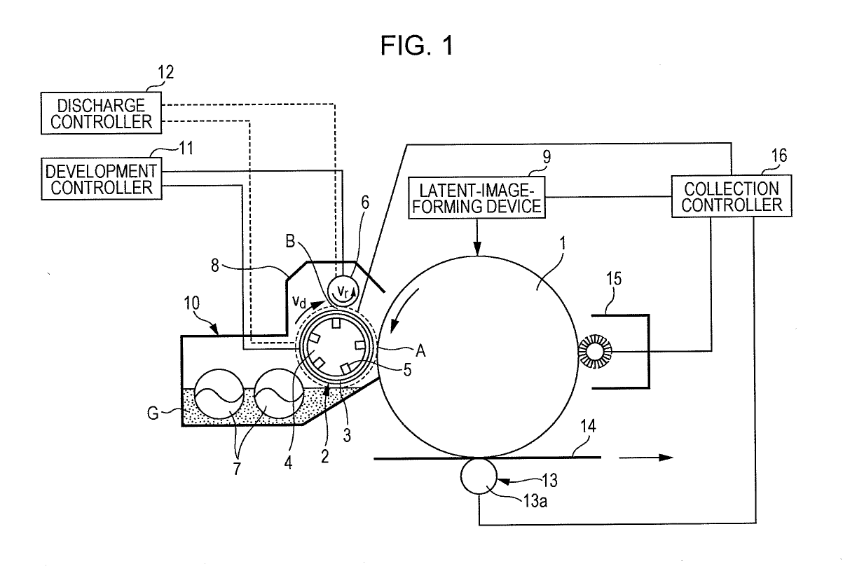

FIG. 1 illustrates an outline of an image forming apparatus to which exemplary embodiments of the present invention are applied.

Referring to FIG. 1, the image forming apparatus includes an image carrier 1 capable of carrying a toner image, a latent-image-forming device 9 configured to form an electrostatic latent image on the image carrier 1, development device 10 configured to develop the electrostatic latent image on the image carrier 1 with a toner into a toner image, a transfer device 13 configured to transfer the toner image on the image carrier 1 to a transfer medium 14, and a cleaning device 15 provided at a position of the image carrier 1 on a downstream side in a direction of rotation of the image carrier 1 with respect to the transfer device 13 and configured to clean off residues on the image carrier 1.

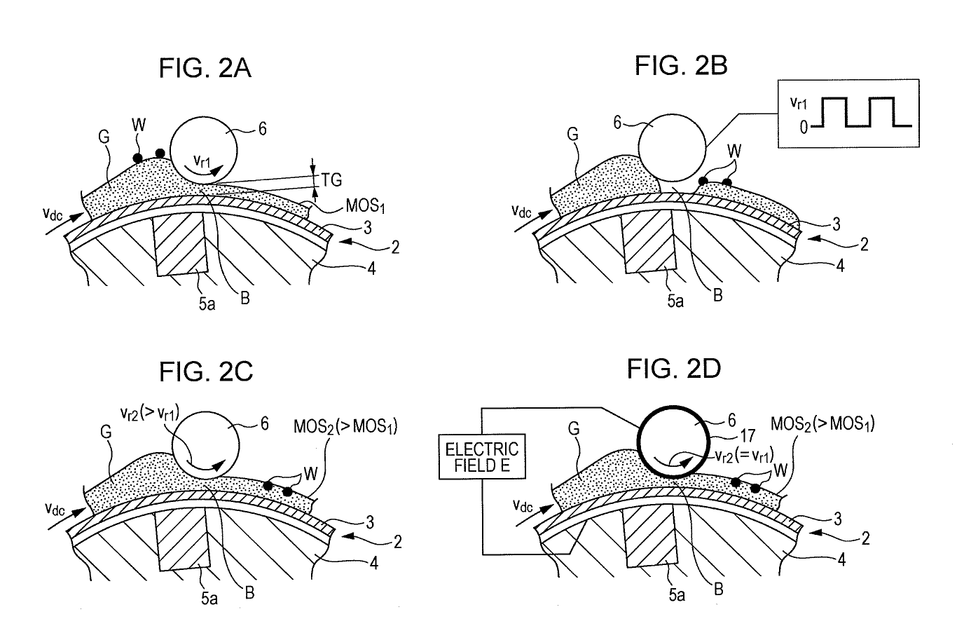

According to a first representative exemplary embodiment of the development device 10, the development device 10 includes a developer carrier 2, a layer-regulating rotating member 6, a development controller 11, and a discharge controller 12. The developer carrier 2 faces the image carrier 1 capable of carrying an electrostatic latent image and is configured to rotate while carrying developer G that contains at least a toner. The developer carrier 2 is also configured to develop the electrostatic latent image on the image carrier 1 with the toner. The layer-regulating rotating member 6 faces the developer carrier 2 with a predetermined gap TG (see FIG. 2A) interposed therebetween.

The layer-regulating rotating member 6 is configured to rotate in a direction that follows the rotation of the developer carrier 2 in such a manner as to regulate the thickness of a layer of the developer G on the developer carrier 2. When development is performed, the development controller 11 controls the developer carrier 2 and the layer-regulating rotating member 6 to rotate at predetermined circumferential speeds v_{d} and vᵣ, respectively, and supplies the developer G on the developer carrier 2 to the electrostatic latent image on the image carrier 1. At a certain time while development is stopped, the discharge controller 12 controls the developer carrier 2 to rotate at a predetermined circumferential speed v_{d} while controlling the layer-regulating rotating member 6 to rotate at a circumferential speed vᵣ that changes intermittently such that the thickness of the layer of the developer G regulated by the layer-regulating rotating member 6 increases and decreases and any pieces of foreign matter and aggregates W (see FIGS. 2A to 2D) that are present in the developer G are discharged together with the layer of the developer G whose thickness is increased and decreased on the developer carrier 2.

Referring to FIG. 1, the development device 10 further includes stirring/transporting members 7 configured to stir and transport the developer G, which contains the toner and a carrier, stored in a development container 8, whereby the toner is sufficiently charged. Subsequently, some developer G is picked up by the developer carrier 2.

To realize the above technical aspect, the image carrier 1 only needs to be capable of having an electrostatic latent image formed thereon and to carry a toner image and may be arbitrarily selected from those of different types such as a photoconductor, a dielectric member, and a circulating carrier member having on a surface thereof rows of pixel electrodes to which latent image voltages corresponding to the electrostatic latent image to be formed are applied.

The latent-image-forming device 9 only needs to be capable of forming an electrostatic latent image on the image carrier 1 and may be arbitrarily selected from those of different-types. If the image carrier 1 is a photoconductor or a dielectric member, a charging device and a latent-image-writing device that utilizes light, ions, or the like may be employed. If the image carrier 1 includes pixel electrodes, latent image voltages corresponding to the electrostatic latent image to be formed may be applied to the pixel electrodes.

The transfer device 13 may be of contact type or of non-contact type. The transfer medium 14 referred to herein may be a recording material, of course, or an intermediate transfer body configured to temporarily carry an image before the image is transferred to the recording material.

The cleaning device 15 only needs to include a cleaning member.

The development device 10 may be used with a two-component developer or a one-component developer.

The developer carrier 2 may be arbitrarily selected from those that are capable of carrying the developer G to be used.

For example, in a method employing a two-component developer, the developer carrier 2 includes a rotating development member 3 having a developer carrying surface and a magnetic member 4 fixedly provided inside the rotating development member 3 and having plural magnetic poles 5 on the circumference thereof. When the rotating development member 3 is rotated, the rotating development member 3 picks up some developer G containing a toner and a carrier with a magnetic force produced by the magnetic poles 5 of the magnetic member 4.

The rotating development member 3 may be a rigid cylindrical body or a flexible thin-film member. The surface roughness of the rotating development member 3 is arbitrary. To make the layer-regulating rotating member 6 effectively exert its layer-regulating function, it is desirable to suppress the force of transporting the developer G exerted by the development member 3. For example, the rotating development member 3 may have a smooth surface with a maximum height of irregularities (a standard based on JIS B 0601:2001) of 5 μm or less or about 5 μm or less.

The magnetic poles 5 of the magnetic member 4 include a transport magnetic pole provided for transporting the developer G, a development magnetic pole provided at a development site A facing the image carrier 1, a layer-regulation magnetic pole 5a (see FIGS. 2A to 2D) provided at a layer regulation site B facing the layer-regulating rotating member 6, an attraction magnetic pole provided for attracting and holding the developer G at a development/attraction site defined on the rotating development member 3, and a separation magnetic pole provided for separating the developer G from the rotating development member 3 at a developer separation site defined on the rotating development member 3. The magnetic poles 5 each have plural functions described above, not a single function.

The layer-regulating rotating member 6 only needs to be rotatable in a direction that follows the rotation of the developer carrier 2 and to face the developer carrier 2 with a predetermined gap interposed therebetween at least such that the thickness of the layer of the developer G is regulatable. The layer-regulating rotating member 6 may be magnetic or non-magnetic and may have any surface roughness selected with consideration for a target thickness of the layer of the developer G. If the surface of the layer-regulating rotating member 6 is too rough, the rough surface increases the force of transporting the developer G too much.

The development controller 11 controls the developer carrier 2 and the layer-regulating rotating member 6 to rotate at respective predetermined circumferential speeds v_{d} (=v_{dc}) and vᵣ (=vᵣ₁) as illustrated in, for example, FIG. 2A. Thus, the target thickness of the layer of the developer G to be realized through the regulation by the layer-regulating rotating member 6 is determined. Specifically, a transporting force produced by the rotation of the layer-regulating rotating member 6 is applied to upper part of the layer of the developer-G on the developer carrier 2. In this state, the developer G passes through the layer regulation site B defined between the developer carrier 2 and the layer-regulating rotating member 6, whereby the amount of developer G transported, hereinafter also referred to as mass on the sleeve (MOS), is regulated to MOS₁, and the resultant developer G is transported toward the development site A. The development controller 11 also produces, for example, a development electric field that allows the electrostatic latent image on the image carrier 1 to be developed.

The discharge controller 12 intermittently changes the circumferential speed vᵣ of the layer-regulating rotating member 6, whereby the amount of developer G on the developer carrier 2 is increased and decreased, and any pieces of foreign matter and aggregates W (see FIGS. 2A to 2D) that are present near the layer-regulating rotating member 6 are discharged together with the layer of the developer G whose thickness is increased and decreased. Here; if a layer of the developer G having a predetermined thickness is formed in the same manner as that employed at the time of development, pieces of foreign matter and aggregates W that are present near the layer-regulating rotating member 6 tend to remain there because the amount of developer G that passes the layer-regulating rotating member 6 does not change.

Exemplary embodiments of the development controller 11 and the discharge controller 12 according to the first representative exemplary embodiment will now be described.

According to an exemplary embodiment of the development controller 11; when development is performed, the circumferential speed vᵣ of the layer-regulating rotating member 6 is variably adjusted, i.e., increased and decreased, in accordance with changes in the target thickness of the layer of the developer G on the developer carrier 2 to be realized through the regulation.

In such an exemplary embodiment where the target thickness of the layer of the developer G to be realized through the regulation by the layer-regulating rotating member 6 is increased and decreased, the target thickness may be increased and decreased appropriately on the basis of image information, developer usage history information, environmental information, or the like.

According to an exemplary embodiment of the discharge controller 12, while development is stopped, the layer-regulating rotating member 6 is controlled to rotate at a circumferential speed vᵣ that changes intermittently between a driven period in which the layer-regulating rotating member 6 is driven to rotate at a predetermined circumferential speed vᵣ and a stopped period in which the layer-regulating rotating member 6 is stopped (vᵣ=0) as illustrated in FIG. 2B, (This is a first exemplary embodiment of an intermittent drive method.)

This exemplary embodiment is applicable not only to a case where the circumferential speed vᵣ of the layer-regulating rotating member 6 is set to one specific value but also to a case where the circumferential speed vᵣ of the layer-regulating rotating member 6 is variably adjusted.

Referring to FIG. 2B, upper part of the layer of the developer G on the developer carrier 2 comes into contact with the layer-regulating rotating member 6 whose circumferential speed vᵣ changes intermittently. The developer G passes through the layer regulation site B defined between the developer carrier 2 and the layer-regulating rotating member 6 while the amount of developer G (MOS) is increased and decreased, and the resultant developer G is transported toward the development site A.

Meanwhile, any pieces of foreign matter and aggregates W that have been present near the layer-regulating rotating member 6 pass through the layer regulation site B together with the layer of the developer G whose thickness is increased and decreased.

According to another exemplary embodiment of the discharge controller 12, while development is stopped, the layer-regulating rotating member 6 is controlled to rotate at a circumferential speed that changes intermittently between a predetermined first circumferential speed and a predetermined second circumferential speed different from the first circumferential speed. (This is a second exemplary embodiment of the intermittent drive method.)

In this exemplary embodiment, the circumferential speed vᵣ of the layer-regulating rotating member 6 only needs to be variably adjusted in such a manner as to change intermittently between the first circumferential speed and the second circumferential speed, and the developer G transported behaves in substantially the same manner as in the first exemplary embodiment of the intermittent drive method described above. The first circumferential speed and the second circumferential speed may be determined arbitrarily. To increase the degree of changes in the thickness of the layer of the developer G, the difference between the first and second circumferential speeds may be set to a sufficiently large value. Specifically, the upper limit of the circumferential speed may be higher than the circumferential speed employed at the time of development.

According to a second representative exemplary embodiment of the development device 10; the development device 10 includes a developer carrier 2, a layer-regulating rotating member 6, a development controller 11, and a discharge controller 12. The developer carrier 2 faces the image carrier 1 capable of carrying an electrostatic latent image and is configured to rotate while carrying developer G that contains at least a toner. The developer carrier 2 is also configured to develop the electrostatic latent image on the image carrier 1 with the toner. The layer-regulating rotating member 6 faces the developer carrier 2 with a predetermined gap TG (see FIG. 2A) interposed therebetween. The layer-regulating rotating member 6 is configured to rotate in a direction that follows the rotation of the developer carrier 2 in such a manner as to regulate the thickness of a layer of the developer G on the developer carrier 2. When development is performed, the development controller 11 controls the developer carrier 2 and the layer-regulating rotating member 6 to rotate at predetermined circumferential speeds v_{d} and vᵣ, respectively, and supplies the developer G on the developer carrier 2 to the electrostatic latent image on the image carrier 1. At a certain time while development is stopped, the discharge controller 12 controls the developer carrier 2 to rotate at a predetermined circumferential speed v_{d} while controlling the layer-regulating rotating member 6 such that the thickness of the layer of the developer G regulated by the layer-regulating rotating member 6 is increased from that employed when development is performed and any pieces of foreign matter and aggregates W that are present in the developer G are discharged together with the layer of the developer G whose thickness is increased on the developer carrier 2 (see FIG. 2C).

In the above technical aspect, the discharge controller 12 and the layer-regulating rotating member 6 are controlled such that the thickness of the layer of the developer G on the developer carrier 2 is increased, whereby any pieces of foreign matter and aggregates W that are present near the layer-regulating rotating member 6 are discharged together with the layer of the developer G whose thickness is increased.

Here, the difference between the second representative exemplary embodiment and the first representative exemplary embodiment will be summarized. In the discharge controller 12 according to the first representative exemplary embodiment, the thickness of the layer of the developer G is increased and decreased. In the discharge controller 12 according to the second representative exemplary embodiment, the thickness of the layer of the developer G is increased from that employed when development is performed. However, the two representative exemplary embodiments are based on a common concept that the state of the layer of the developer G is changed from that predetermined for the development purpose so that any pieces of foreign matter and aggregates W included in the developer G are discharged.

Exemplary embodiments of the second representative exemplary embodiment will now be described.

According to an exemplary embodiment, when development is performed, the development controller 11 variably adjusts the circumferential speed vᵣ of the layer-regulating rotating member 6 such that the circumferential speed vᵣ increases and decreases with changes in the target thickness of the layer of the developer G on the developer carrier 2 to be realized through the regulation. Furthermore, at a certain time while development is stopped, the discharge controller 12 controls the layer-regulating rotating member 6 to rotate at a circumferential speed vᵣ₂ that is faster than the circumferential speed vᵣ (vᵣ₁) employed when development is performed (vᵣ₂>vᵣ₁), as illustrated in FIG. 2C. (This is a first exemplary embodiment of a developer-layer-thickness-increasing method.)

In this exemplary embodiment, the circumferential speed vᵣ of the layer-regulating rotating member 6 is variably adjusted, whereby the thickness of the layer of the developer G is increased and decreased. In this case, upper part of the layer of the developer G on the developer carrier 2 comes into contact with the layer-regulating rotating member 6 rotating at a circumferential speed vᵣ faster than that employed at the time of development. The developer G passes through the layer regulation site B defined between the developer carrier 2 and the layer-regulating rotating member 6 while the amount of developer G (MOS) transported is increased, and the resultant developer G is transported toward the development site A.

Meanwhile, any pieces of foreign matter and aggregates W that are present near the layer-regulating rotating member 6 pass through the layer regulation site B together with the layer of the developer G whose thickness is increased.

According to another exemplary embodiment of the developer-layer-thickness-increasing method, referring to FIG. 2D, while development is stopped, the developer carrier 2 and the layer-regulating rotating member 6 are controlled to rotate at predetermined circumferential speeds v_{d} (=v_{dc}) and vᵣ (vᵣ₂=vᵣ₁), respectively, and an electric field E that allows the surface of the layer-regulating rotating member 6 to attract some toner 17 is produced between the developer carrier 2 and the layer-regulating rotating member 6. (This is a second exemplary embodiment of the developer-layer-thickness-increasing method.)

In this exemplary embodiment, some toner 17 is attracted to the surface of the layer-regulating rotating member 6. When the toner 17 is attracted to the surface of the layer-regulating rotating member 6; the surface roughness of the layer-regulating rotating member 6 now having the toner 17 temporarily increases compared with that in a state obtained before the toner 17 is attracted. Accordingly, the developer transporting force increases with the increase in the surface roughness of the layer-regulating rotating member 6. Correspondingly, the thickness of the layer of the developer G that passes the layer-regulating rotating member 6 increases. Thus, in this exemplary embodiment also, any pieces of foreign matter and aggregates W that are present near the layer-regulating rotating member 6 pass through the layer regulation site B together with the layer of the developer G whose thickness is increased.

In the image forming apparatus, the pieces of foreign matter and aggregates W discharged from the development device 10 need to be appropriately collected.

Here, pieces of foreign matter and aggregates W may be collected by any method. To effectively prevent the contamination inside the image forming apparatus, the image forming apparatus may include a collection controller 16 that controls the latent-image-forming device 9, the development device 10, the image carrier 1, and the cleaning device 15 such that any pieces of foreign matter and aggregates W in the developer G discharged together with the layer of the developer G on the developer carrier 2 by the discharge controller 12 are collected in the cleaning device 15 via the image carrier 1.

Exemplary embodiments of the collection controller 16 will now be described.

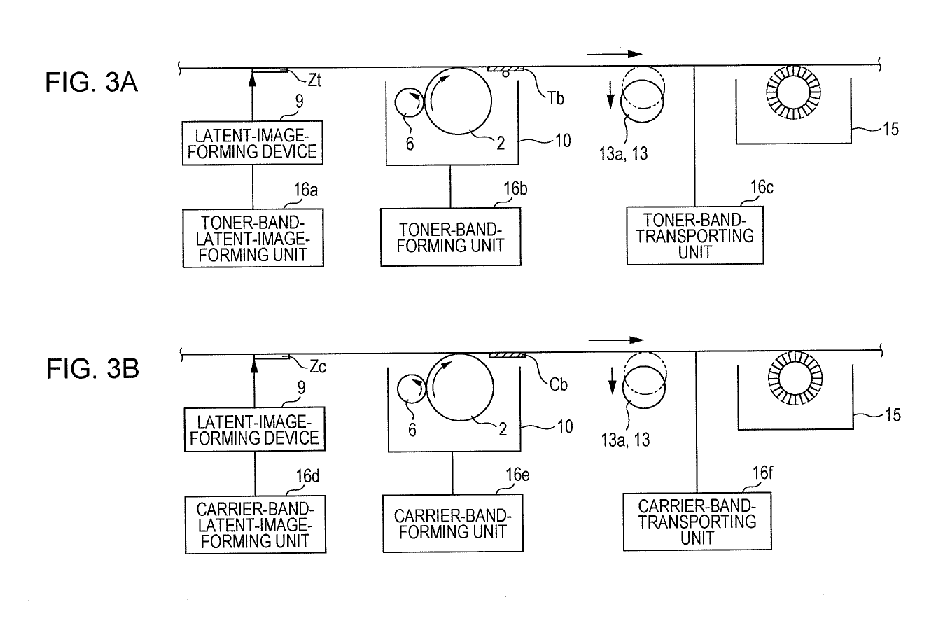

According to a first exemplary embodiment of the collection controller 16, referring to FIGS. 1 and 3A, the collection controller 16 includes a toner-band-latent-image-forming unit 16a, a toner-band-forming unit 16b, and a toner-band-transporting unit 16c. At a certain time while image formation is stopped, the toner-band-latent-image-forming unit 16a causes the latent-image-forming device 9 to form, on the image carrier 1, a toner-band latent image Zt developable with the toner and extending in a direction intersecting the direction of rotation of the image carrier 1. At a certain time while development is stopped; the discharge controller 12 causes the layer-regulating rotating member 6 to operate such that the thickness of the layer of the developer G is increased and decreased or is increased compared with that employed at the time of development. When the layer of the developer G whose thickness has been changed reaches the development site A defined in the development device 10, the toner-band-forming unit 16b causes the toner-band latent image Zt on the image carrier 1 to reach the development site A defined in the development device 10 and causes the development device 10 to develop the toner-band latent image Zt with the toner into a toner band Tb under conditions conforming to those employed at the time of development. The toner-band-transporting unit 16c causes the toner band Tb formed on the image carrier 1 by the toner-band-forming unit 16b to be transported to the cleaning device 15 while preventing the transfer device 13 from transferring the toner band Tb to anywhere.

This exemplary embodiment employs a method of collecting foreign matter and aggregates W by using the toner band Tb. In this method, a toner band Tb is formed on the image carrier 1, and any pieces of foreign matter and aggregates W having charges close to the charge of the toner are moved together with the toner band Tb with the rotation of the image carrier 1, whereby the pieces of foreign matter and aggregates W are collected in the cleaning device 15.

According to a second exemplary embodiment of the collection controller 16, the development device 10 employs developer G containing a toner and a carrier. Referring to FIGS. 1 and 3B, the collection controller 16 includes a carrier-band-latent-image-forming unit 16d, a carrier-band-forming unit 16e, and a carrier-band-transporting unit 16f. At a certain time while image formation is stopped, the carrier-band-latent-image-forming unit 16d causes the latent-image-forming device 9 to form, on the image carrier 1, a carrier-band latent image Zc capable of attracting the carrier and extending in a direction intersecting the direction of rotation of the image carrier 1. At a certain time while development is stopped, the discharge controller 12 causes the layer-regulating rotating member 6 to operate such that the thickness of the layer of the developer G is increased and decreased or is increased compared with that employed at the time of development. When the layer of the developer G whose thickness has been changed reaches the development site A defined in the development device 10, the carrier-band-forming unit 16e causes the carrier-band latent image Zc on the image carrier 1 to reach the development site A defined in the development device 10 and causes the development device 10 to allow the carrier-band latent image Zc to attract the carrier under conditions that allow the attraction of the carrier but are different from those employed at the time of development, whereby a carrier band Cb is obtained. The carrier-band-transporting unit 16f causes the carrier band Cb formed on the image carrier 1 by the carrier-band-forming unit 16e to be transported to the cleaning device 15 while preventing the transfer device 13 from transferring the carrier band Cb to anywhere.

This exemplary embodiment employs a method of collecting foreign matter and aggregates W by using the carrier band Cb. In this method, a carrier band Cb is formed on the image carrier 1, and any pieces of foreign matter and aggregates W having charges close to the charge of the carrier are moved together with the carrier band Cb with the rotation of the image carrier 1, whereby the pieces of foreign matter and aggregates W are collected in the cleaning device 15.

According to an exemplary embodiment where either of the above collection controllers 16 is employed, the transfer device 13 includes a transfer member 13a configured to be pressed against the image carrier 1 directly or with the transfer medium 14 interposed therebetween. When the toner band Tb or the carrier band Cb passes through a transfer site, the transfer member 13a is retracted from the position where the transfer member 13a is pressed against the image carrier 1 directly or with the transfer medium 14 interposed therebetween, whereby the toner band Tb or the carrier band Cb on the image carrier 1 is prevented from coming into contact with the transfer member 13a or the transfer medium 14.

In such an exemplary embodiment, the pieces of foreign matter and aggregates W discharged onto the image carrier 1 are collected in the cleaning device 15 without coming into contact with the transfer member 13a (a transfer roller, a transfer belt, or the like) or the transfer medium 14. Hence, there is no possibility that the pieces of foreign matter and aggregates W may be transferred to and contaminate the transfer member 13a or the transfer medium 14.

The operation of controlling the discharge and collection of foreign matter and aggregates W through the discharge controller 12 and the collection controller 16 may be performed for every predetermined number of times of image formation or every predetermined number of times of developer supply.

In an exemplary embodiment where the operation of controlling the discharge and collection is performed for every predetermined number of times of image formation, the development device 10 is regularly subjected to maintenance for foreign matter and aggregates W. In an exemplary embodiment where the operation of controlling the discharge and collection is performed for every predetermined number of times of developer supply, when some developer G that has deteriorated is requested to be disposed of instead of supplying fresh developer G, any pieces of foreign matter and aggregates W included in the deteriorated developer G are discharged and are collected in the cleaning device 15 without the aid of a mechanism of disposing of the developer G that may be provided in the development device 10.

From the viewpoint of discharging and collecting foreign matter and aggregates W, the image forming apparatus may include a defect detector (not illustrated) configured to detect any defects in the layer of the developer G on the developer carrier 2 or in the toner image on the image carrier 1 or the transfer medium 14, and the operation of controlling the discharge and collection of foreign matter and aggregates W through the discharge controller 12 and the collection controller 16 may be performed when the defect detector has detected any defects in the layer of the developer G or the toner image.

In an exemplary embodiment where the object of detection by the defect detector is the layer of the developer G, for example, a magnetic brush of developer G formed on the developer carrier 2 may be measured with a laser displacement gauge or the like. In such a case, if any local nonuniformity is detected in the magnetic brush of developer G, it is understood that the magnetic brush of developer G has a defect due to the presence of foreign matter and aggregates. W.

In an exemplary embodiment where the object of detection by the defect detector is the toner image on the image carrier 1 or the transfer medium 14, the toner image may be scanned with, for example, a reading sensor extending in a direction intersecting the direction of rotation or movement of the image carrier 1 or the transfer medium 14. If any image defects such as image dropouts are detected in the toner image, it is presumed that pieces of foreign matter and aggregates W are present in portions of the layer of the developer G corresponding to the positions of the image dropouts.

A more specific exemplary embodiment of the present invention will now be described with reference to the accompanying drawings.

### Specific Exemplary Embodiment

### Overall Configuration of Image Forming Apparatus

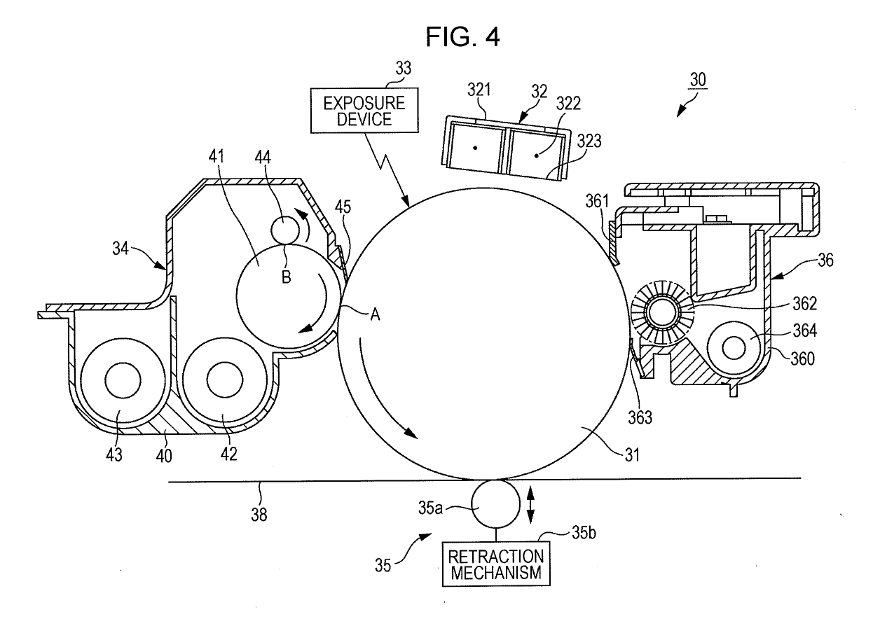

FIG. 4 illustrates an overall configuration of an image forming apparatus 30 according to a specific exemplary embodiment of the present invention.

The image forming apparatus 30 illustrated in FIG. 4 includes a drum-type photoconductor 31 as an image carrier, a charging device 32 that charges the photoconductor 31, an exposure device 33 that writes with light an electrostatic latent image on the photoconductor 31 charged by the charging device 32, a development device 34 that visualizes with developer G (toner) the electrostatic latent image written on the photoconductor 31 into a toner image, transfer device 35 that transfers the toner image visualized by the development device 34 to a recording material 38 as a transfer medium, and a cleaning device 36 that cleans off toner residues on the photoconductor 31 after the transfer performed by the transfer device 35.

In the specific exemplary embodiment, the image transferred to the recording material 38 is fixed by a fixing device (not illustrated), and the recording material 38 having the fixed image is discharged to the outside. In the specific exemplary embodiment, the transfer medium is the recording material 38. The transfer medium may be any other body, such as an intermediate transfer body that temporarily carries the toner image before the toner image is transferred to the recording material 38.

The charging device 32 includes, for example, a charger container 321. Discharge wires 322 and grid electrodes 323 as charging members are provided in the charger container 321. The charging device 32 may be of any other type, such as a type employing charging members in the form of rollers.

The exposure device 33 may be a laser scanning device, a light-emitting-diode (LED) array, or the like.

The development device 34 employs a two-component development method in which a two-component developer containing a toner and a carrier is used. The development device 34 will be described in detail separately below.

The transfer device 35 only needs to produce a transfer electric field that causes the toner image on the photoconductor 31 to be electrostatically transferred to the recording material 38. For example, the transfer device 35 includes a roller-type transfer member 35a to which a transfer bias is applied. In the specific exemplary embodiment, the transfer member 35a is movable by a retraction mechanism 35b between a transfer position where the recording material 38 is held between the transfer member 35a and the photoconductor 31 and a retracted position where the transfer member 35a is retracted from the transfer position.

The transfer device 35 is not limited to the above and may be, for example, a transfer corotron employing discharge wires.

The cleaning device 36 includes a cleaner container 360 having an opening on a side thereof facing the photoconductor 31 and in which toner residues are collected. A plate-like cleaning member 361, such as a blade or a scraper, is provided at a downstream-side edge of the opening of the cleaner container 360 in the direction of rotation of the photoconductor 31. A brush-type or roller-type rotating cleaning member 362 is provided on the upstream side of the plate-like cleaning member 361 in the direction of rotation of the photoconductor 31. A sealing member 363 is provided at an upstream-side edge of the opening of the cleaner container 360 in the direction of rotation of the photoconductor 31. A transport member 364 (for example, a rotating shaft member having a helical blade provided therearound) that transports the toner residues collected is also provided in the cleaner container 360 below the rotating cleaning member 362 so that the toner residues collected are disposed of.

### Development Device

In the specific exemplary embodiment, the development device 34 includes a developer container 40 having an opening on a side thereof facing the photoconductor 31 and in which the two-component developer G containing the toner and the carrier is stored. A development roller 41 capable of carrying and transporting the developer G is provided at a position of the developer container 40 that faces the photoconductor 31. Stirring/transporting members 42 and 43 that stir and transport the developer G so as to triboelectrically charging the toner are provided in the developer container 40 at the back of the development roller 41 in such a manner as to, for example, horizontally extend parallel to each other. Some developer G stirred and transported by the stirring/transporting members 42 and 43 is picked up by the development roller 41, whereby a layer of the developer G is formed on the development roller 41. The thickness of the layer of the developer G on the development roller 41 is regulated by a layer regulating member 44. Subsequently, the developer G is supplied to the development site A that faces the photoconductor 31.

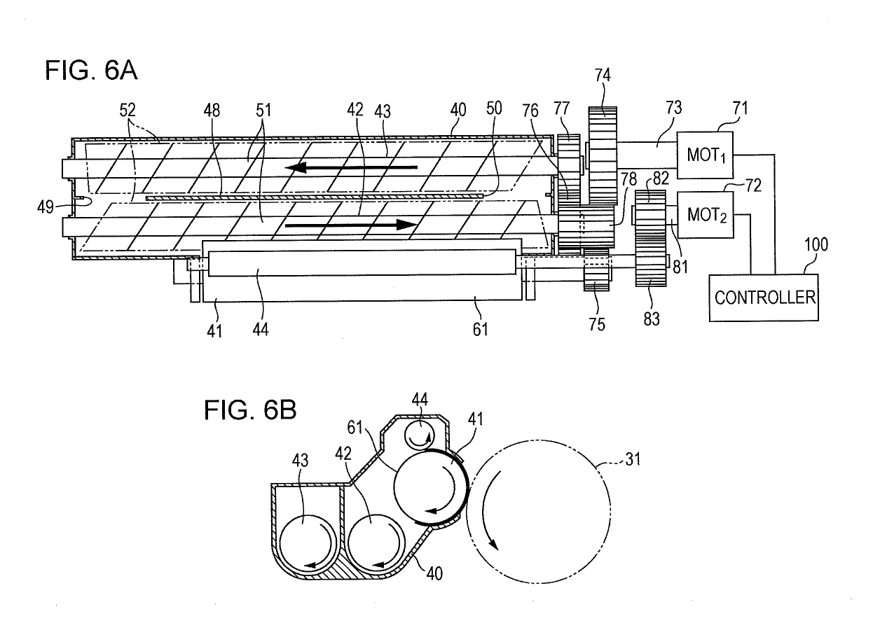

Referring to FIG. 6A, the developer container 40 has a partition 48 extending in the axial direction of the development roller 41 and with which the internal space of the developer container 40 is divided into two spaces. The partition 48 has through holes 49 and 50 near two respective ends in the longitudinal direction thereof. The stirring/transporting members 42 and 43 each include, for example, a rotating shaft member 51 and a helical blade 52 provided around the rotating shaft member 51. The stirring/transporting members 42 and 43 are provided in the two respective spaces separated by the partition 48. The developer G is circulated and transported by the stirring/transporting members 42 and 43 via the through holes 49 and 50.

The developer container 40 has a sealing member 45 (see FIG. 4) at an upper edge of the opening thereof.

### Development Roller

In the specific exemplary embodiment, the development roller 41 is out of contact with the photoconductor 31 with a gap interposed therebetween at the development site A. The gap between the photoconductor 31 and the development roller 41 is set to such a value that the gap is filled with the developer G when the development roller 41 has carried an amount of developer G (a mass on the sleeve, hereinafter abbreviated to MOS) that realizes development as required at the development site A.

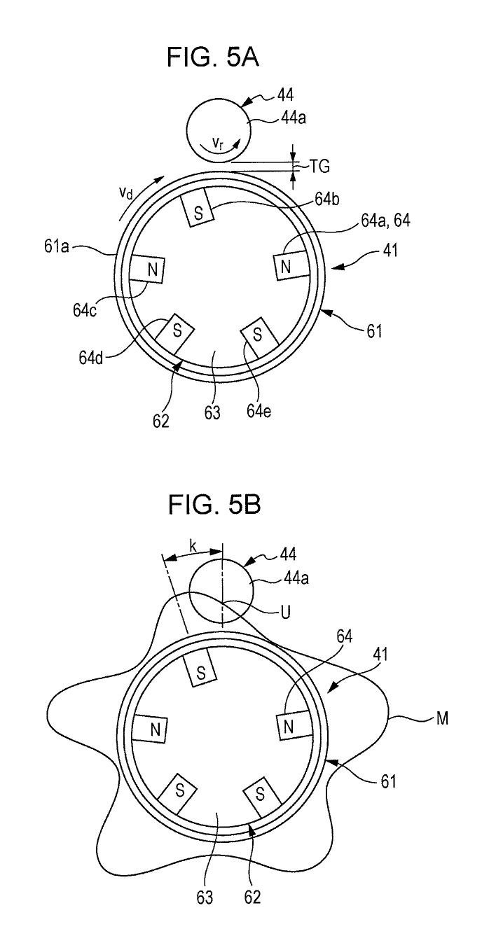

The development roller 41 illustrated in FIGS. 4 and 5A and 5B includes a rotatable development sleeve 61 made of a non-magnetic material (for example, SUS304) and having a cylindrical shape and a magnetic roller 62 fixedly provided inside the development sleeve 61.

In the specific exemplary embodiment, the development sleeve 61 has a smooth surface 61a. The smooth surface 61a is obtained by, for example, grinding the surface of a plain pipe made of a non-magnetic material that is to become the development sleeve 61. The surface roughness, i.e., the maximum height of irregularities Rz (JIS B 0601:2001), of the development sleeve 61 is set to 5 μm or less or about 5 μm or less.

Referring to FIGS. 5A and 5B, the magnetic roller 62 includes a non-magnetic roller member 63 and plural magnetic poles 64 (in the specific exemplary embodiment, five magnetic poles 64a to 64e) provided on the circumference of the roller member 63. Specifically, the magnetic poles 64 include a development magnetic pole 64a (a north pole in the specific exemplary embodiment) with which the developer G is supplied to the development site A, a layer-regulation magnetic pole 64b (a south pole in the specific exemplary embodiment) with which the thickness of the layer of the developer G is regulated in combination with the layer regulating member 44 at the layer regulation site B, an attraction magnetic pole 64d (a south pole in the specific exemplary embodiment) with which the developer G is attracted to and held on the development roller 41, transport magnetic pole 64c (a north pole in the specific exemplary embodiment) provided between the layer-regulation magnetic pole 64b and the attraction magnetic pole 64d and with which the developer G is transported, and a separation magnetic pole 64e (a south pole in the specific exemplary embodiment) provided between the development magnetic pole 64a and the attraction magnetic pole 64d and that produces a repulsive magnetic field with respect to the attraction magnetic pole 64d, whereby the developer G on the development roller 41 is separated from the development roller 41. The development magnetic pole 64a, the layer-regulation magnetic pole 64b, the attraction magnetic pole 64d, and the separation magnetic pole 64e also each function as a transport magnetic pole in combination with a corresponding one of adjacent magnetic poles that has a different polarity.

A magnetic-flux-density distribution M produced by the magnetic poles 64 (64a to 64e) of the magnetic roller 62 is set to such a degree that, when the development sleeve 61 is rotated, the developer G on the development sleeve 61 is retained on and transported by the development sleeve 61 with the aid of a magnetic force having the magnetic-flux-density distribution M.

### Layer Regulating Member

Referring to FIG. 5A, the layer regulating member 44 is a rotatable roller member (hereinafter also referred to as rotating trimmer, according to need) and rotates in a direction that follows the rotation of the development sleeve 61.

The layer regulating member (rotating trimmer) 44 faces the development sleeve 61 with a predetermined gap TG interposed therebetween, that is, the layer regulating member (rotating trimmer) 44 is out of contact with the development sleeve 61. The gap TG is appropriately set within a range of, for example, 0.035 to 1.5 mm so that a desired amount of developer G (MOS) is transported to the development site A.

The layer regulating member (rotating trimmer) 44 is made of a non-magnetic material (for example, SUS304) or a magnetic material (for example, SUS416). The layer regulating member (rotating trimmer) 44 has a smooth surface 44a that is obtained by grinding the surface of a plain pipe that is to become the layer regulating member (rotating trimmer) 44 such that the surface has a maximum height of irregularities Rz (JIS B 0601:2001) of 5 μm or less or about 5 μm or less.

Referring to FIG. 5B, the layer regulating member (rotating trimmer) 44 only needs to be provided at a position corresponding to the layer-regulation magnetic pole 64b of the development roller 41. In the specific exemplary embodiment, a position in the layer regulation site B where the gap TG between the layer regulating member (rotating trimmer) 44 and the development roller 41 is the smallest is displaced from a peak-magnetic-force position of the layer-regulation magnetic pole 64b toward the downstream side in the direction of transport of the developer G by an angle k, and the layer-regulation magnetic pole 64b has a magnetic force U of 30 mT to 60 mT at the smallest-gap position.

### Transmission Mechanisms

FIG. 6A illustrates transmission mechanisms included in the development device 34 according to the specific exemplary embodiment.

The development device 34 illustrated in FIG. 6A is driven by two drive motors (MOT₁ and MOT₂) 71 and 72.

A transmission mechanism based on the drive motor (MOT₁) 71 is configured as follows. A motor drive shaft 73 has a drive gear 74 coaxially provided thereon. The rotating shaft of the development sleeve 61 of the development roller 41 and the rotating shafts of the stirring/transporting members 42 and 43 each have a corresponding one of transmission gears 75 to 77 coaxially provided at one end thereof. The transmission gears 76 and 77 mesh with each other. The drive gear 74 and the transmission gear 76 are connected to each other with an intermediate transmission gear 78 interposed therebetween and meshing therewith.

A transmission mechanism based on the drive motor (MOT₂) 72 is configured as follows. A motor drive shaft 81 has a drive gear 82 coaxially provided thereon. The rotating shaft of the layer regulating member (rotating trimmer) 44 has a transmission gear 83 coaxially provided thereon. The drive gear 82 and the transmission gear 83 mesh with each other.

The two drive motors 71 and 72 are driven to rotate and are stopped in accordance with control signals sent from a controller 100.

In the specific exemplary embodiment, referring to FIGS. 6A and 6B, the drive motor 71 rotates or stops the development sleeve 61 of the development roller 41 and the stirring/transporting members 42 and 43 simultaneously. The drive motor 72 rotates or stops the layer regulating member (rotating trimmer) 44.

### Drive Control Mechanism

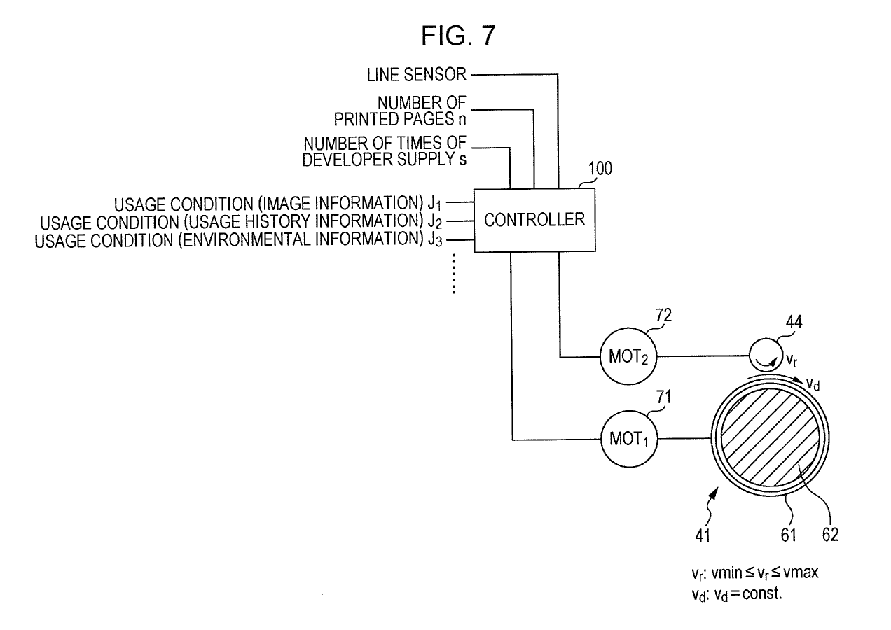

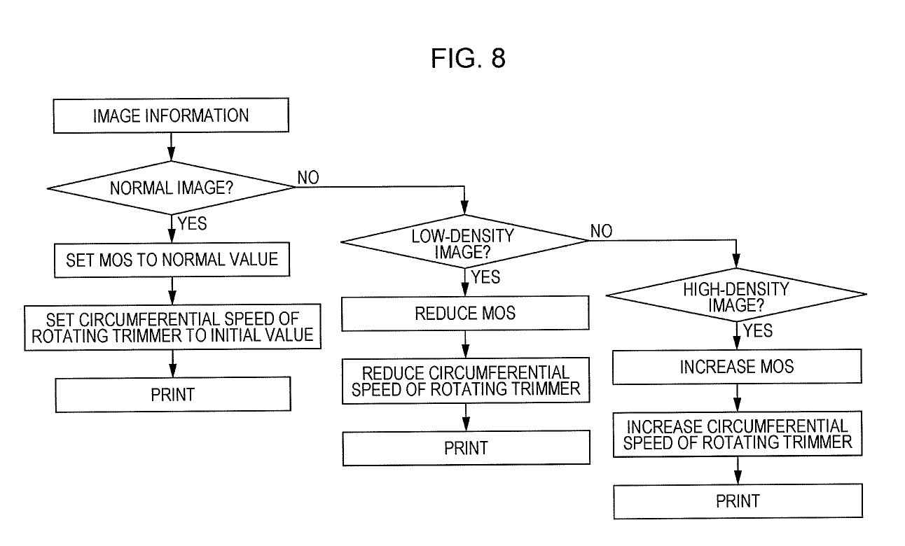

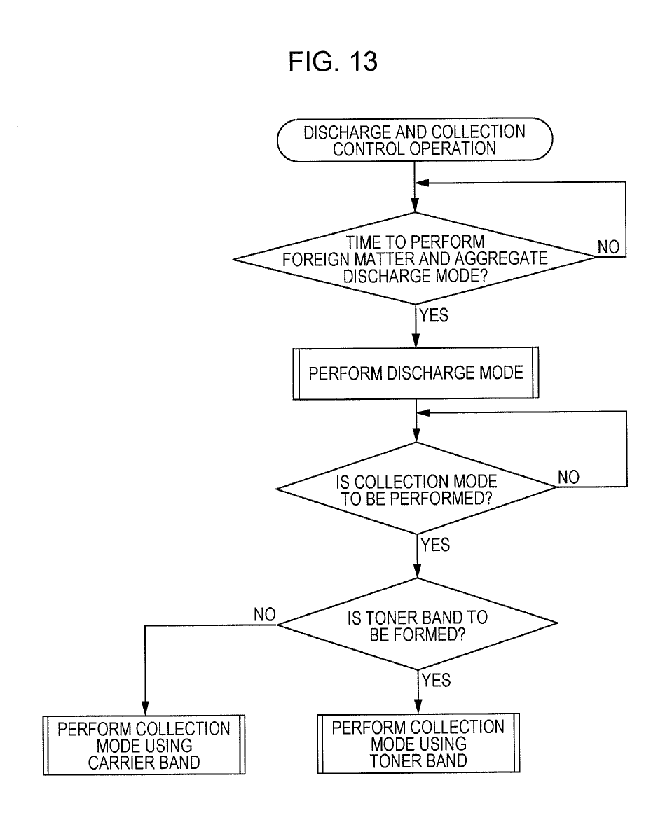

In the specific exemplary embodiment, the controller 100 is a computer system including a central processing unit (CPU), a random access memory (RAM), a read-only memory (ROM), and input/output ports. Referring to FIG. 7, the controller 100 receives signals indicating, for example, usage conditions J (J₁ to J₃, for example) of the image forming apparatus and parameters for determining whether to perform a discharge mode for discharging foreign matter and aggregates from the development device 34 (in the specific exemplary embodiment, the parameters include number of printed pages n, number of times of developer supply s, an output from a line sensor that detects the quality of the image on the recording material 38, and so forth). Subsequently, the controller 100 executes through the CPU thereof a development control program (see FIGS. 8 to 10, for example) or a foreign matter/aggregate discharge and collection control program (see FIG. 13), the programs being pre-installed in the ROM. Then, the controller 100 sends control signals to the two drive motors (MOT₁ and MOT₂), 71 and 72 and thus controls the driving of the development sleeve 61 of the development roller 41 and the layer regulating member (rotating trimmer) 44 through the respective drive motors 71 and 72.

In the specific exemplary embodiment, the circumferential speed v_{d} of the development sleeve 61 of the development roller 41 is set to a predetermined constant (const.) while the circumferential speed vᵣ of the layer regulating member (rotating trimmer) 44 is variably set within a range between a predetermined lower limit vmin and a predetermined upper limit vmax.

### Development Control Operation

A development control operation performed in the development device 34 according to the specific exemplary embodiment will now be described.

Examples of the development control operation according to the specific exemplary embodiment are as follows.

### Image-Information-Based MOS Control Operation

Referring to FIG. 8, this control operation focuses on the image density indicated by, for example, image information J₁. In this control operation, the level of image density is determined from among preset levels: low density, high density, and normal density between the former two. If the image is a normal image (a normal-density image), a normal MOS value is set and the circumferential speed vᵣ of the layer regulating member (rotating trimmer) 44 is set to an initial value. Then, printing (development) is performed:

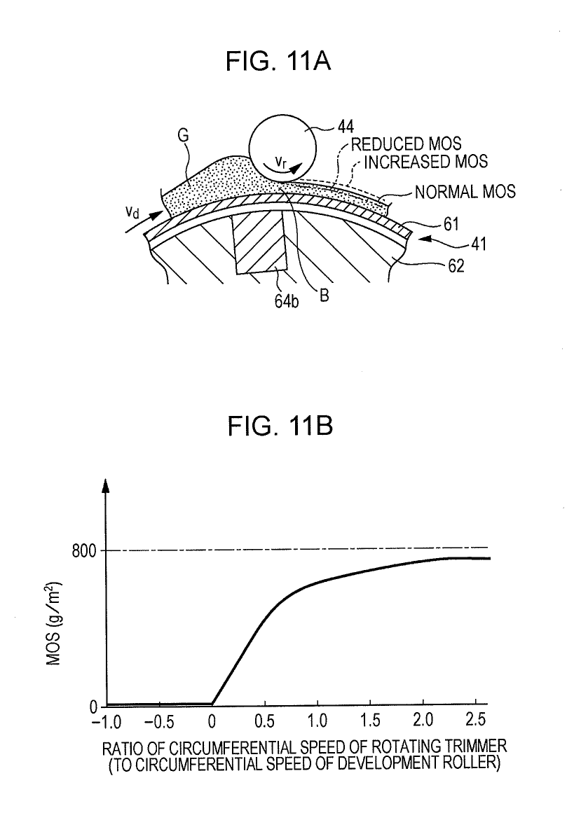

Specifically, referring to FIG. 11A, when the circumferential speed vᵣ of the layer regulating member (rotating trimmer) 44 is set to the initial value, a normal transporting force is applied to the developer G with the rotation of the rotating trimmer 44. The developer G that has received the normal transporting force passes through the layer regulation site B defined at the rotating trimmer 44, and an amount of developer G corresponding to the normal MOS value is transported to the development site A (see FIG. 4).

If the image information indicates a low-density image, a reduced MOS value is set and the circumferential speed vᵣ of the layer regulating member (rotating trimmer) 44 is reduced from the initial value. Then, printing (development) is performed.

In this case, referring to FIG. 11A, when the circumferential speed vᵣ of the layer regulating member (rotating trimmer) 44 is reduced, a reduced transporting force is applied to the developer G with the rotation of the rotating trimmer 44 at the reduced circumferential speed vᵣ. The developer G that has received the reduced transporting force passes through the layer regulation site B defined at the rotating trimmer 44, and an amount of developer G corresponding to the reduced MOS value (represented by the dash-dot-dot line) is transported to the development site A (see FIG. 4).

In this case, since the MOS is reduced, the low-density image is printed as a fine image.

If the image information indicates a high-density image, an increased MOS value is set and the circumferential speed vᵣ of the layer regulating member (rotating trimmer) 44 is increased from the initial value. Then, printing (development) is performed.

In this case, referring to FIG. 11A, when the circumferential speed vᵣ of the layer regulating member (rotating trimmer) 44 is increased, an increased transporting force is applied to the developer G with the rotation of the rotating trimmer 44 at the increased circumferential speed vᵣ. The developer G that has received the increased transporting force passes through the layer regulation site B defined at the rotating trimmer 44, and an amount of developer G corresponding to the increased MOS value (represented by the dotted line) is transported to the development site A (see FIG. 4).

In this case, since the MOS is increased, the high-density image is printed as a thick image.

### Usage-History-Based MOS Control Operation

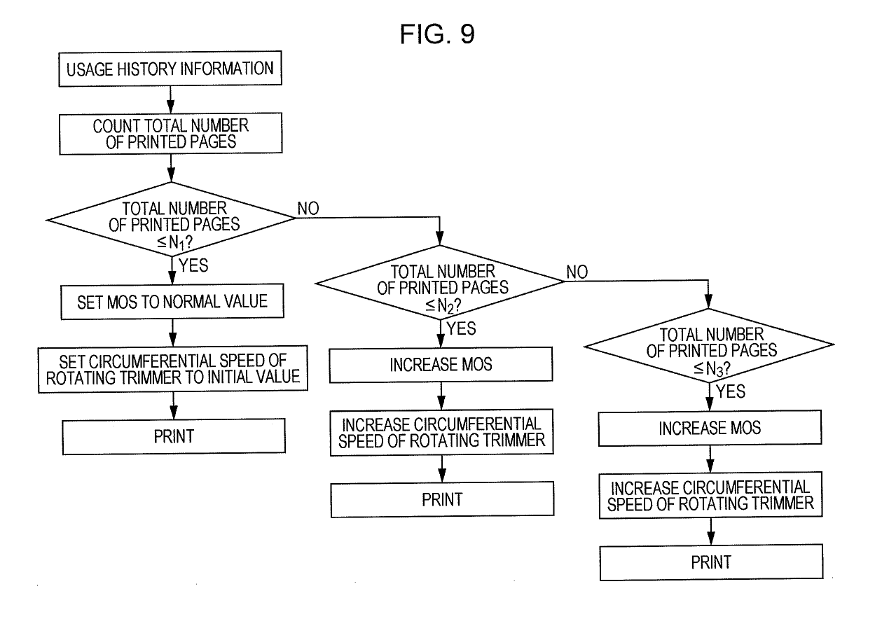

Referring to FIG. 9, this control operation focuses on the number of printed pages indicated by, for example, usage history information J₂. In this control operation, the number of printed pages is compared with preset thresholds N₁, N₂, and N₃ (N₁<N₂<N₃). If the total number of printed pages is N₁ or less, a normal MOS value is set and the circumferential speed vᵣ of the layer regulating member (rotating trimmer) 44 is set to an initial value. Then, printing (development) is performed.

In this case, referring to FIG. 11A, a normal transporting force is applied to the developer G with the rotation of the rotating trimmer 44. The developer G that has received the normal transporting force passes through the layer regulation site B defined at the rotating trimmer 44, and an amount of developer G corresponding to the normal MOS value is transported to the development site A (see FIG. 4).

If the total number of printed pages is greater than N₁ and is less than or equal to N₂, an increased MOS value is set and the circumferential speed vᵣ of the layer regulating member (rotating trimmer) 44 is increased from the initial value. Then, printing (development) is performed.

In this case, referring to FIG. 11A, when the circumferential speed vᵣ of the layer regulating member (rotating trimmer) 44 is increased, an increased transporting force is applied to the developer G with the rotation of the rotating trimmer 44 at the increased circumferential speed vᵣ. The developer G that has received the increased transporting force passes through the layer regulation site B defined at the rotating trimmer 44, and an amount of developer G corresponding to the increased MOS value (represented by the dotted line) is transported to the development site A (see FIG. 4).

If the total number of printed pages is greater than N₂ and is less than or equal to N₃, a further increased MOS value is set and the circumferential speed vᵣ of the layer regulating member (rotating trimmer) 44 is further increased from the initial value. Then, printing (development) is performed.

In this case, referring to FIG. 11A, when the circumferential speed vᵣ of the layer regulating member (rotating trimmer) 44 is further increased, a further increased transporting force is applied to the developer G with the rotation of the rotating trimmer 44 at the further increased circumferential speed vᵣ. The developer G that has received the further increased transporting force passes through the layer regulation site B defined at the rotating trimmer 44, and an amount of developer G corresponding to the further increased MOS value (represented by the dotted line) is transported to the development site A (see FIG. 4).

### Environmental-Information-Based MOS Control Operation

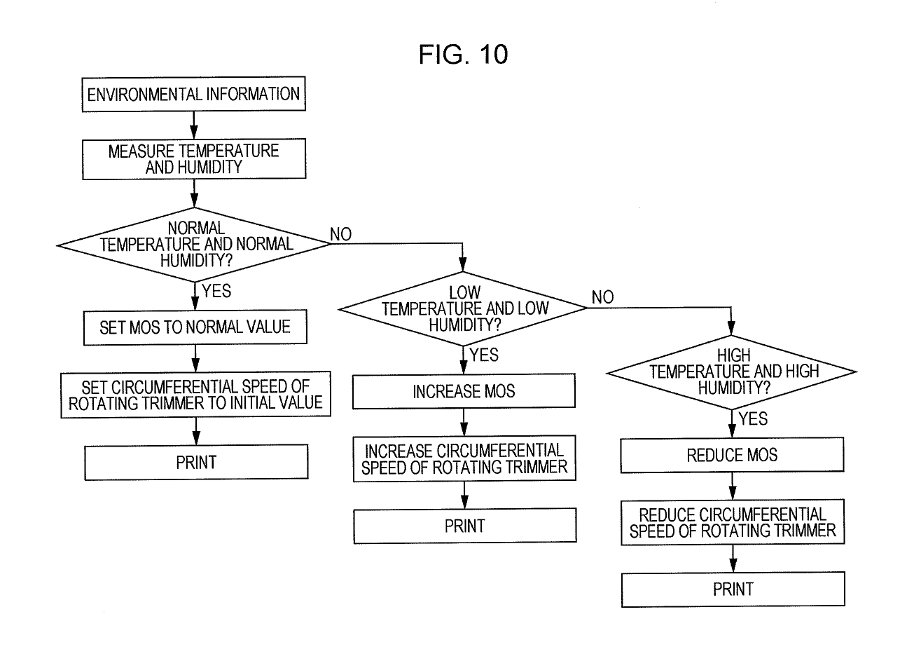

Referring to FIG. 10, this control operation focuses on the temperature and humidity indicated by, for example, environmental information J₃. In this control operation, the level of temperature and humidity is determined from among preset levels: low temperature and low humidity, high temperature and high humidity, and normal temperature and normal humidity between the former two. If the environmental information indicates normal temperature and normal humidity, a normal MOS value is set and the circumferential speed vᵣ of the layer regulating member (rotating trimmer) 44 is set to an initial value. Then, printing (development) is performed.

In this case, referring to FIG. 11A, a normal transporting force is applied to the developer G with the rotation of the rotating trimmer 44. The developer G that has received the normal transporting force passes through the layer regulation site B defined at the rotating trimmer 44, and an amount of developer G corresponding to the normal MOS value is transported to the development site A (see FIG. 4).

If the environmental information indicates low temperature and low humidity, an increased MOS value is set and the circumferential speed vᵣ of the layer regulating member (rotating trimmer) 44 is increased from the initial value. Then, printing (development) is performed.

In this case, referring to FIG. 11A, when the circumferential speed vᵣ of the layer regulating member (rotating trimmer) 44 is increased, an increased transporting force is applied to the developer G with the rotation of the rotating trimmer 44 at the increased circumferential speed vᵣ. The developer G that has received the increased transporting force passes through the layer regulation site B defined at the rotating trimmer 44, and an amount of developer G corresponding to the increased MOS value (represented by the dotted line) is transported to the development site A (see FIG. 4).

In this case, since the MOS is increased, the image is printed with a sufficient level of quality despite the low temperature and low humidity.

If the environmental information indicates high temperature and high humidity, a reduced MOS value is set and the circumferential speed vᵣ of the layer regulating member (rotating trimmer) 44 is reduced from the initial value. Then, printing (development) is performed.

In this case, referring to FIG. 11A, when the circumferential speed vᵣ of the layer regulating member (rotating trimmer) 44 is reduced, a reduced transporting force is applied to the developer G with the rotation of the rotating trimmer 44 at the reduced circumferential speed vᵣ. The developer G that has received the reduced transporting force passes through the layer regulation site B defined at the rotating trimmer 44, and an amount of developer G corresponding to the reduced MOS value (represented by the dash-dot-dot line) is transported to the development site A (see FIG. 4).

In this case, since the MOS is reduced, the image is printed with a sufficient level of quality despite the high temperature and high humidity.

### Operation of Adjusting Circumferential Speed of Layer Regulating Member

In the specific exemplary embodiment, when changes in the MOS occurring with changes in the circumferential speed vᵣ of the layer regulating member (rotating trimmer) 44 are measured, a tendency illustrated in FIG. 11B is observed.

In the graph illustrated in FIG. 11B, the horizontal axis represents the ratio of the circumferential speed vᵣ of the rotating trimmer 44 to the circumferential speed v_{d} of the development roller 41. It is understood that, when the circumferential speed vᵣ of the rotating trimmer 44 is changed on condition that the rotating trimmer 44 is rotated in the direction that follows the rotation of the development roller 41 (specifically, the development sleeve 61) as illustrated in FIG. 11A, the MOS gradually increases up to a value that is almost 800 g/m² in the specific exemplary embodiment.

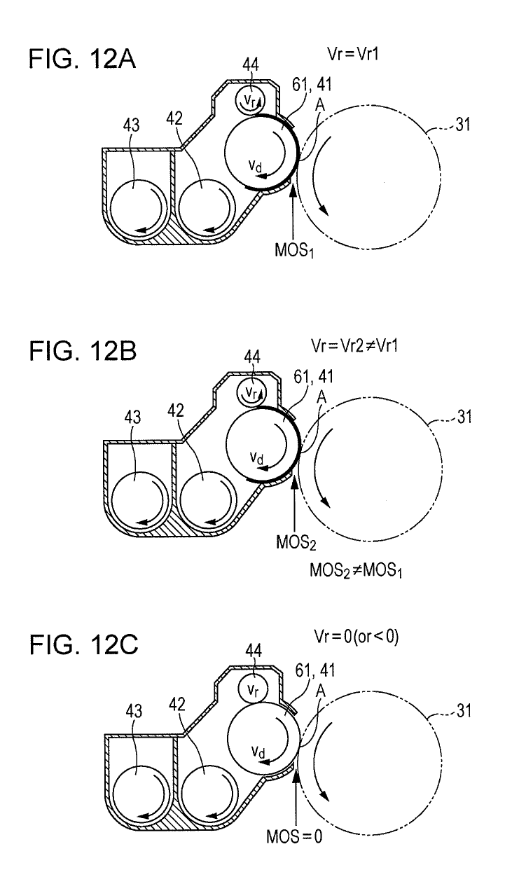

Referring to FIG. 12A, suppose that the development roller 41 (specifically, the development sleeve 61) is rotating at a constant circumferential speed v_{d} and the circumferential speed vᵣ of the rotating trimmer 44 is vᵣ₁, and let the amount of developer G that reaches the development site A in this case be MOS₁.

Referring now to FIG. 12B, when the circumferential speed vᵣ of the rotating trimmer 44 is equal to vᵣ₂ but is not equal to vᵣ₁ while the development roller 41 (specifically, the development sleeve 61) is rotating at the constant circumferential speed v_{d}, the amount of developer G that reaches the development site A changes to MOS₂, which is not equal to MOS₁.

Here, the following holds:

when vᵣ₂>vᵣ₁, MOS₂>MOS₁, and

when vᵣ₂<vᵣ₁, MOS₂<MOS₁.

Referring now to FIGS. 11B and 12C, when the rotation of the rotating trimmer 44 is stopped while the development roller 41 (specifically, the development sleeve 61) is rotating at the constant circumferential speed v_{d}, the MOS becomes zero. In this state, the supply of developer G to the development site A is stopped.

In the specific exemplary embodiment, if the rotating trimmer 44 is rotated in a direction that is against the direction of rotation of the development roller 41 (specifically, the development sleeve 61) while the development roller 41 (specifically, the development sleeve 61) is rotating at the constant circumferential speed v_{d}, the MOS becomes zero, as illustrated in FIGS. 11B and 12C. Accordingly, similarly to the case where the rotation of the rotating trimmer 44 is stopped, the supply of developer G to the development site A is stopped.

### Discharge and Collection Control Operation

In the specific exemplary embodiment, while the development device 34 is used for a certain period of time, foreign matter such as paper lint may be taken into the developer container 40 or the developer G may form aggregates thereof in the developer container 40. If any pieces of such foreign matter and aggregates are present near the rotating trimmer 44 as the layer regulating member or, particularly, if any pieces of such foreign matter and aggregates remain caught at the layer regulation site B, some trouble may arise in regulating the layer of the developer G to a uniform thickness by using the rotating trimmer 44. That is, any pieces of foreign matter and aggregates produce grooves in the layer of the developer G that is to be regulated. If the layer of the developer G having such grooves reaches the development site A and is supplied to the electrostatic latent image on the photoconductor 31 at the time of development, the resulting toner image developed on the photoconductor 31 may have image dropouts in the form of white lines.

In this respect, the controller 100 according to the specific exemplary embodiment illustrated in FIG. 7 performs a discharge and collection control operation in which any pieces of foreign matter and aggregates in the development device 34 are discharged and collected on the regular basis or when any signs of image defects are detected.

In the discharge and collection control operation according to the specific exemplary embodiment, referring to FIG. 13, it is determined whether or not it is time to perform a discharge mode for discharging foreign matter and aggregates. If it has been determined that it is time to perform the discharge mode, the discharge mode for discharging foreign matter and aggregates from the development device 34 is performed. In conjunction with this, a collection mode for collecting the foreign matter and aggregates discharged from the development device 34 is performed. The collection mode is selected from a mode provided for a toner-band method and a mode provided for a carrier-band method.

### When to Perform Discharge Mode

In the specific exemplary embodiment, whether or not it is time to perform the discharge mode is determined on the basis of any of the following pieces of information.

(1) Number of Printed Pages n

This information is intended for a case where the discharge mode is performed regularly for every predetermined number of printed pages n so that no foreign matter and aggregates remain in the development device 34.

(2) Number of Times of Developer Supply s

In many cases, the development device 34 employs a method in which the developer G is supplied with the consumption of toner. Particularly, in a method where the developer G as a whole including not only the toner but also the carrier is supplied, the developer-storing capacity of the development device 34 tends to become large. Therefore, a discharge mechanism that discharges deteriorated developer G (basically, the carrier) may be added.

In general, developer is supplied on the basis of the amount of toner consumed. Therefore, the actual amount of developer to be supplied varies depending on occasions. Hence, in the specific exemplary embodiment, the discharge mode is performed regularly for every number of times of developer supply s obtained by conversion based on a preset fixed amount of supply, whereby deteriorated developer G is discharged together with any pieces of foreign matter and aggregates. Such a discharge mode performed in accordance with the number of times of developer supply s may take the place of the aforementioned operation of discharging deteriorated developer G performed by the discharge mechanism. That is, the discharge mechanism may be omitted.

In a method in which the amount of developer G supplied is directly measured, the amount of developer G supplied may be employed instead of the number of times of developer supply s.

(3) Irregular Output from Line Sensor

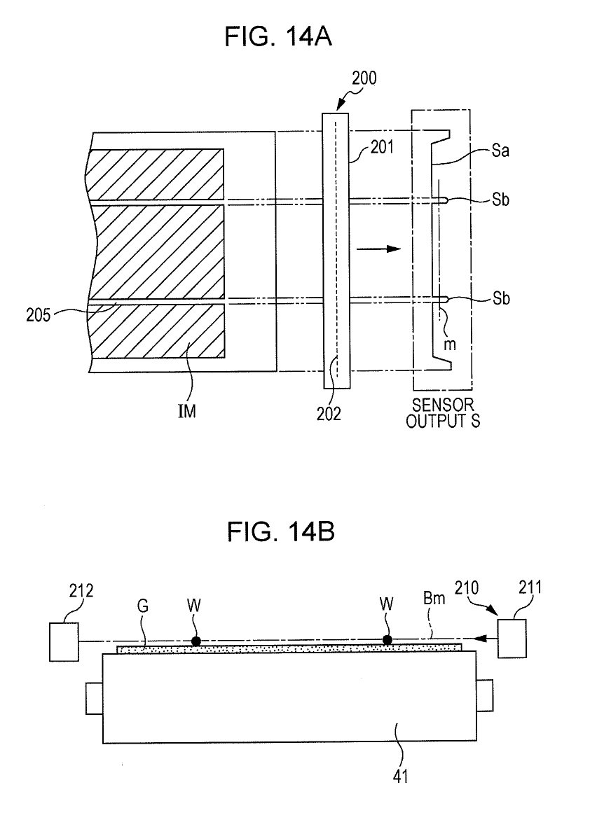

FIG. 14A illustrates an exemplary method of detecting the quality of an image on the recording material 38.

Referring to FIG. 14A, a line sensor 200 is provided at a position in a transport path along which the recording material 38 is transported. The line sensor 200 is an image sensor having along body extending in a width direction of the recording material 38 that intersects the direction of transport of the recording material 38. The line sensor 200 includes many sensor elements 202 in a sensor array 201 that are arrayed in the width direction of the recording material 38, thereby optically detecting information on the density of an image IM forted on the recording material 38.

For example, supposed that an image IM as a two-dimensional image, such as a halftone image, formed on the recording material 38 includes defects 205 in the form of white lines resulting from the presence of pieces of foreign matter and aggregates W in the development device 34. Regarding the image IM, a sensor output S illustrated in FIG. 14A is obtained through the line sensor 200. The sensor output S indicates a tendency in which a density level Sb at positions corresponding to the defects 205 in the form of white lines is low (the level of optical sensor output at the foregoing positions is high) compared with a density level Sa in portions of the image IM where the halftone image is formed as intended.

In view of the above, an image IM as a two-dimensional halftone image is formed on the recording material 38 in, for example, a mode for testing the image quality, and the sensor output S from the line sensor 200 is observed. Prior to this, a threshold m of the sensor output S is set for identification of any defects 205. If it is detected that the sensor output S has exceeded the threshold m, it is assumed that there is a defect 205 and it is determined that the discharge mode needs to be performed.

In the specific exemplary embodiment, the quality of an image formed on the recording material 38 is detected. In an image forming apparatus according to an exemplary embodiment employing a photoconductor 31 and an intermediate transfer body, the quality of an image formed on the photoconductor 31 or the intermediate transfer body may be detected with the line sensor 200.

The layer of the developer G formed in the development device 34 is basically regulated by the rotating trimmer 44 in such a manner as to have a uniform thickness. In a case where there are many pieces of foreign matter and aggregates W in part of the layer of the developer G, those pieces of foreign matter and aggregates W tend to gather near the rotating trimmer 44. Hence, as illustrated in FIG. 14B, for example, a detector 210 that detects foreign matter and aggregates W may be provided in the development device 34.

The detector 210 according to an exemplary embodiment includes a light source 211 and a light-receiving sensor 212 provided at two axial ends, respectively, of the development roller 41 such that an optical path Bm of a beam emitted from the light source 211 to the light-receiving sensor 212 is defined slightly above a level corresponding to the thickness of the layer of the developer G on the development roller 41 obtained after the regulation. In such a configuration, the optical path Bm is blocked if, for example, there are many pieces of foreign matter and aggregates W in the developer G. Accordingly, the output from the light-receiving sensor 212 becomes lower than a preset threshold, indicating the presence of foreign matter and aggregates W. Thus, it is determined that the discharge mode needs to be performed.

(4) Others

Whether or not it is time to perform the discharge mode may be determined not only on the basis of any of the above pieces of information but also with any of the following timings:

when the image forming apparatus is turned on;

at times designated by the user;

at maintenance times designated by the service engineer; and

when the developer cartridge is replaced or when developer is supplied.

### Discharge Mode

Exemplary embodiments of the discharge mode will now be described.

### First Exemplary Embodiment of Discharge Mode

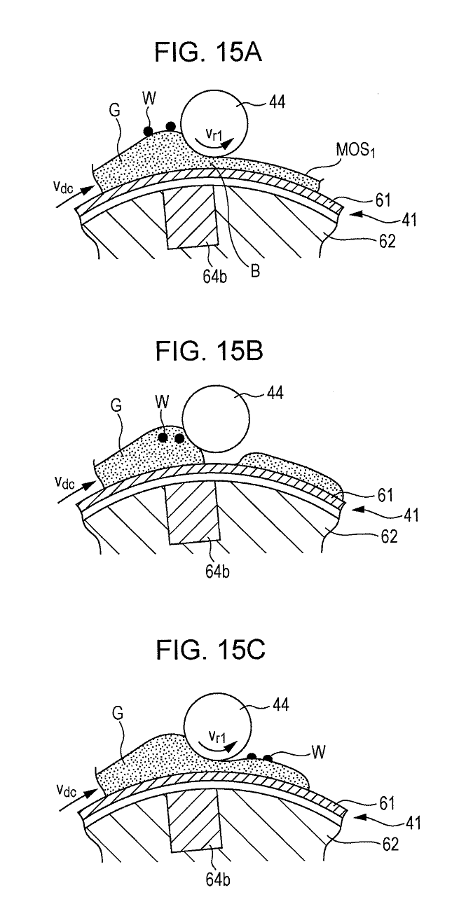

A first exemplary embodiment of the discharge mode is based on a method in which the thickness of the layer of the developer G that passes the rotating trimmer 44 is changed in such a manner as to increase and decrease. Referring to FIGS. 15A to 15C, when the discharge mode is performed, the rotating trimmer 44 is controlled to rotate at a circumferential speed vᵣ that changes intermittently between a driven period in which the rotating trimmer 44 is driven to rotate at a predetermined circumferential speed vᵣ₁ and a stopped period in which the rotating trimmer 44 is stopped (vᵣ=0). In the first exemplary embodiment, the development roller 41 rotates at the circumferential speed v_{d} (v_{dc}) employed at the time of development.

In the first exemplary embodiment, referring to FIGS. 15A to 15C, upper part of the layer of the developer G on the development roller 41 comes into contact with the rotating trimmer 44 whose circumferential speed vᵣ changes intermittently. The developer G passes through the layer regulation site B defined between the development roller 41 and the rotating trimmer 44 while the amount of developer G (MOS) is increased and decreased between MOS₁ and 0, and the resultant developer G is transported toward the development site A.

Meanwhile, any pieces of foreign matter and aggregates W that are present near the rotating trimmer 44 pass through the layer regulation site B together with the layer of the developer G whose thickness is increased and decreased.

### Second Exemplary Embodiment of Discharge Mode

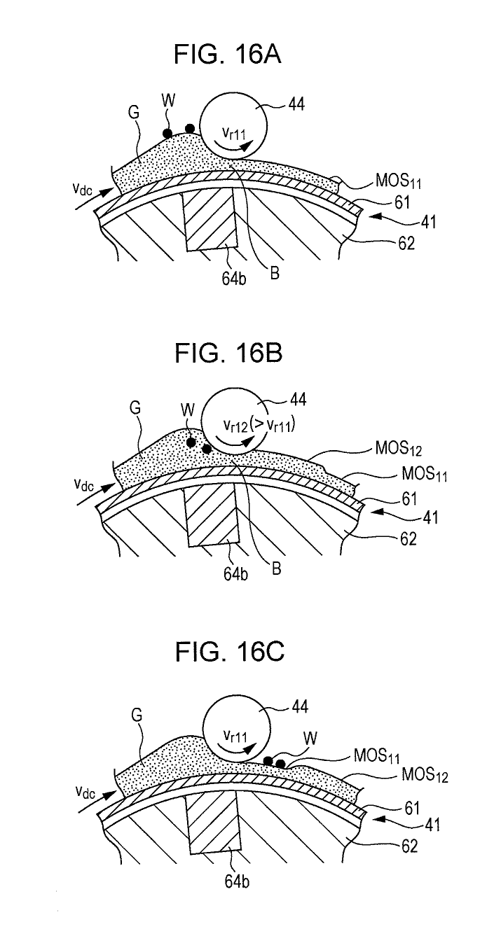

A second exemplary embodiment of the discharge mode is also based on the method in which the thickness of the layer of the developer G that passes the rotating trimmer 44 is changed in such a manner as to increase and decrease. Referring to FIGS. 16A to 16C, when the discharge mode is performed, the rotating trimmer 44 is controlled to rotate at a circumferential speed vᵣ that changes intermittently between a predetermined first circumferential speed vᵣ₁₁ and a predetermined second circumferential speed vᵣ₁₂ different from the first circumferential speed vᵣ₁₁ (vᵣ₁₂>vᵣ₁₁). In the second exemplary embodiment, the development roller 41 rotates at the circumferential speed v_{d} (v_{dc}) employed at the time of development.

In the second exemplary embodiment, referring to FIGS. 16A to 16C, upper part of the layer of the developer G on the development roller 41 comes into contact with the rotating trimmer 44 whose circumferential speed vᵣ changes intermittently. The developer G passes through the layer regulation site B defined between the development roller 41 and the rotating trimmer 44 while the amount of developer G (MOS) is increased and decreased between MOS₁₁ and MOS₁₂ (MOS₁₂>MOS₁₁), and the resultant developer G is transported toward the development site A.

Meanwhile, any pieces of foreign matter and aggregates W that are present near the rotating trimmer 44 pass through the layer regulation site B together with the layer of the developer G whose thickness is increased and decreased.

### Third Exemplary Embodiment of Discharge Mode

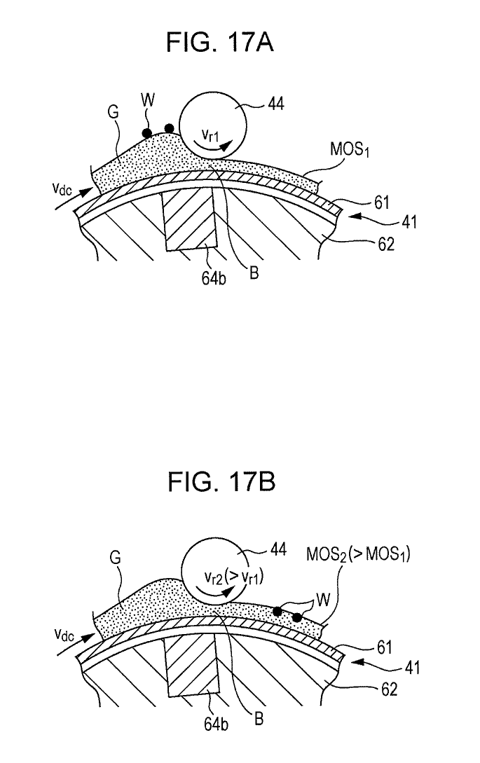

A third exemplary embodiment of the discharge mode is based on a method in which the thickness of the layer of the developer G that passes the rotating trimmer 44 is increased. Referring to FIGS. 17A and 17B, when the discharge mode is performed, the rotating trimmer 44 is controlled to rotate at a circumferential speed vᵣ₂ that is higher than the circumferential speed vᵣ₁ employed at the time of development (vᵣ₂>vᵣ₁). In the third exemplary embodiment, the development roller 41 rotates at the circumferential speed v_{d} (v_{dc}) employed at the time of development.

In the third exemplary embodiment, upper part of the layer of the developer G on the development roller 41 comes into contact with the rotating trimmer 44 rotating at a circumferential speed vᵣ higher than that employed at the time of development. The developer G passes through the layer regulation site B defined between the development roller 41 and the rotating trimmer 44 while the amount of developer G. (MOS) is increased, and the resultant developer G is transported toward the development site A.

Meanwhile, any pieces of foreign matter and aggregates W that are present near the rotating trimmer 44 pass through the layer regulation site B together with the layer of the developer G whose thickness is increased.

### Fourth Exemplary Embodiment of Discharge Mode

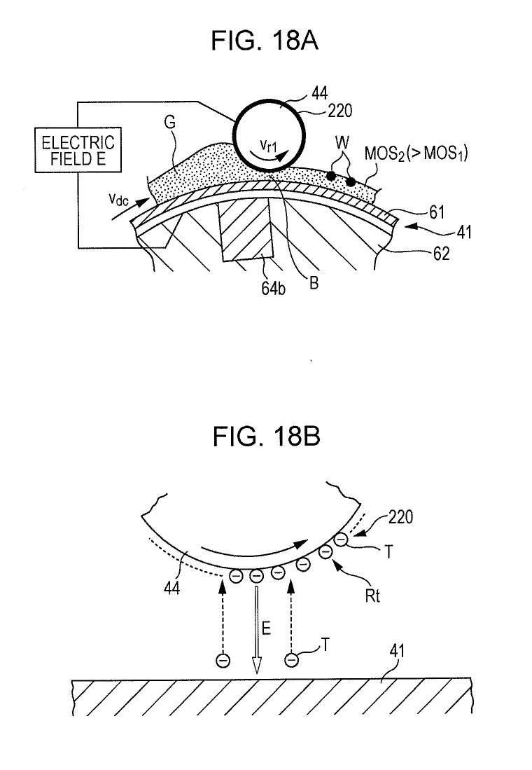

A fourth exemplary embodiment of the discharge mode is also based on the method in which the thickness of the layer of the developer G that passes the rotating trimmer 44 is increased. Referring to FIG. 18A, when the discharge mode is performed, the development roller 41 and the rotating trimmer 44 are controlled to rotate at respective predetermined circumferential speeds v_{d} (=v_{dc}) and vᵣ (vᵣ₂=vᵣ₁) and an electric field E is produced between the development roller 41 and the rotating trimmer 44 such that the surface of the rotating trimmer 44 attracts toner particles T.

The fourth exemplary embodiment concerns a method in which toner particles T are attracted to the surface of the rotating trimmer 44. Referring to FIG. 18B, when toner particles T are attracted to the surface of the rotating trimmer 44, the toner particles T form an attracted-toner layer 220 on the surface of the rotating trimmer 44. With the presence of the attracted-toner layer 220, a surface roughness Rt of the rotating trimmer 44 temporarily increases compared with that obtained before the attraction of the toner particles T. Accordingly, the developer transporting force exerted by the rotating trimmer 44 having the increased surface roughness Rt increases. Consequently, the thickness of the layer of the developer G that passes the rotating trimmer 44 increases correspondingly. Therefore, in the fourth exemplary embodiment also, any pieces of foreign matter and aggregates W that are present near the rotating trimmer 44 pass through the layer regulation site B together with the layer of the developer G whose thickness is increased.

The fourth exemplary embodiment may be combined with any of the first to third exemplary embodiments.

### Collection Mode

When any of the above discharge modes is performed, the pieces of foreign matter and aggregates W are transported to the development site A together with the layer of the developer G with the rotation of the development roller 41.

In the specific exemplary embodiment, a collection mode for collecting the pieces of foreign matter and aggregates W discharged from the development device 34 is performed.

Herein, two exemplary embodiments of the collection mode will be described: a collection mode using a toner band, and a collection mode using a carrier band.

Which of the collection modes is to be selected may be determined in advance on the basis of the number of times of performance of the discharge mode. For example, the two collection modes may be performed alternately, or the collection mode using a carrier band may be performed for every p times of performance of the collection mode using a toner band. In the specific exemplary embodiment, either of the collection modes is performed after the discharge mode. Needless to say, both of the collection modes may be performed sequentially after the discharge mode.

### Collection Mode Using Toner Band

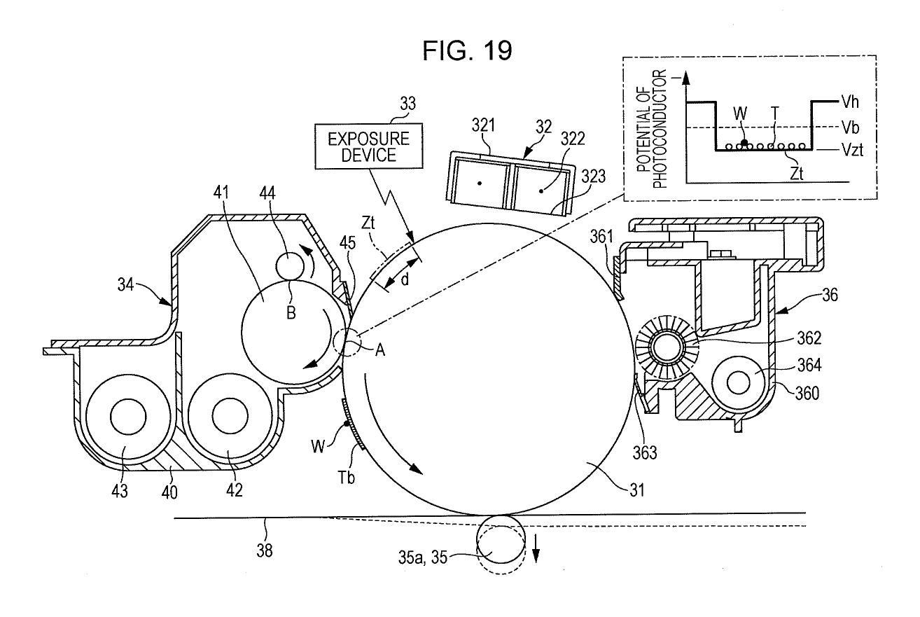

The collection mode using a toner band is performed through steps described below, as illustrated in FIG. 19.

(1) Step of Forming Toner-Band Latent Image

In this step, the latent-image-forming device (the charging device 32 and the exposure device 33) forms, on the photoconductor 31, a toner-band latent image Zt developable with toner particles T and extending in the width direction that intersects the direction of rotation of the photoconductor 31.

A length d of the toner-band latent image Zt in the direction of rotation of the photoconductor 31 may be larger than or equal to the circumference of the development roller 41. In that case, a toner-band latent image Zt extends over the entirety of a length corresponding to the circumference of the development roller 41 and picks up pieces of foreign matter and aggregates W that may be present at any position on the circumference of the development roller 41.

(2) Step of Forming Toner Band

In this step of the discharge mode, the rotating trimmer 44 changes the thickness of the layer of the developer G such that the thickness increases and decreases or increases compared with that employed at the time of development. Then, when the layer of the developer G whose thickness has been changed reaches the development site A defined in the development device 34, the toner-band latent image Zt formed on the photoconductor 31 is made to reach the development site A defined in the development device 34. Furthermore, the toner-band latent image Zt is developed with toner particles T by using the development device 34 under conditions conforming to those employed at the time of development, whereby a toner band Tb is formed.

In this state, the toner band Tb includes foreign matter and aggregates W as well as the toner particles T.

The conditions conforming to those employed at the time of development refer to conditions under which the toner-band latent image Zt is developable with the toner particles T on the development roller 41. Letting the initial potential of the charge on the photoconductor 31 be Vh, the potential of the toner-band latent image Zt be v_{zt}, and the development voltage placed across the development roller 41 be Vb, the following holds:

|Vh|>|Vb|>|V_{zt}|

(3) Step of Transporting Toner Band

In this step, the toner band Tb formed on the photoconductor 31 is transported to the cleaning device 36 without being transferred to anywhere by the transfer device 35.

In this step, the transfer member 35a of the transfer device 35 is made to retract from the transfer position by the retraction mechanism 35b. Therefore, the toner band Tb on the photoconductor 31 is transported to the cleaning device 36 without being transferred to the transfer member 35a and is collected in the cleaning device 36.

### Collection Mode Using Carrier Band

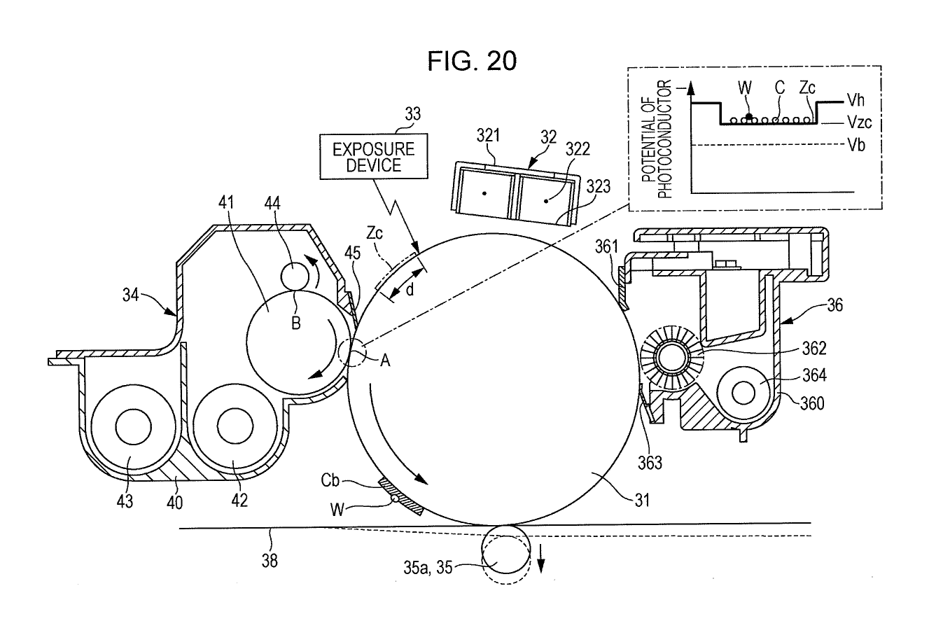

The collection mode using a carrier band is performed through steps described below, as illustrated in FIG. 20.

(1) Step of Forming Carrier-Band Latent Image

In this step, the latent-image-forming device (the charging device 32 and the exposure device 33) forms, on the photoconductor 31, a carrier-band latent image Zc developable with carrier particles C and extending in the width direction that intersects the direction of rotation of the photoconductor 31.

A length d of the carrier-band latent image Zc in the direction of rotation of the photoconductor 31 may be larger than or equal to the circumference of the development roller 41 for the same reason as in the case of the toner-band latent image Zt.

(2) Step of Forming Carrier Band

In this step of the discharge mode, the rotating trimmer 44 changes the thickness of the layer of the developer G such that the thickness increases and decreases or increases compared with that employed at the time of development. Then, when the layer of the developer G whose thickness has been changed reaches the development site A defined in the development device 34, the carrier-band latent image Zc formed on the photoconductor 31 is made to reach the development site A defined in the development device 34. Furthermore, the carrier-band latent image Zc is developed with carrier particles C by using the development device 34 under conditions that allow the attraction of carrier particles C but are different from those employed at the time of development, whereby a carrier band Cb is formed.

In this state, the carrier band Cb includes foreign matter and aggregates W as well as the carrier particles C.

The conditions that allow the attraction of carrier particles C but are different from those employed at the time of development refer to conditions under which carrier particles C on the development roller 41 are attractable to the carrier-band latent image Zc. Letting the initial potential of the charge on the photoconductor 31 be Vh, the potential of the carrier-band latent image Zc be v_{zc}, and the development voltage placed across the development roller 41 be Vb, the following holds:

|Vh|>|V_{zc}|>|Vb|

(3) Step of Transporting Carrier Band

In this step, the carrier band Cb formed on the photoconductor 31 is transported to the cleaning device 36 without being transferred to anywhere by the transfer device 35.

In this step, the transfer member 35a of the transfer device 35 is made to retract from the transfer position by the retraction mechanism 35b. Therefore, the carrier band Cb on the photoconductor 31 is transported to the cleaning device 36 without being transferred to the transfer member 35a and is collected in the cleaning device 36.

### EXAMPLES

### Example 1

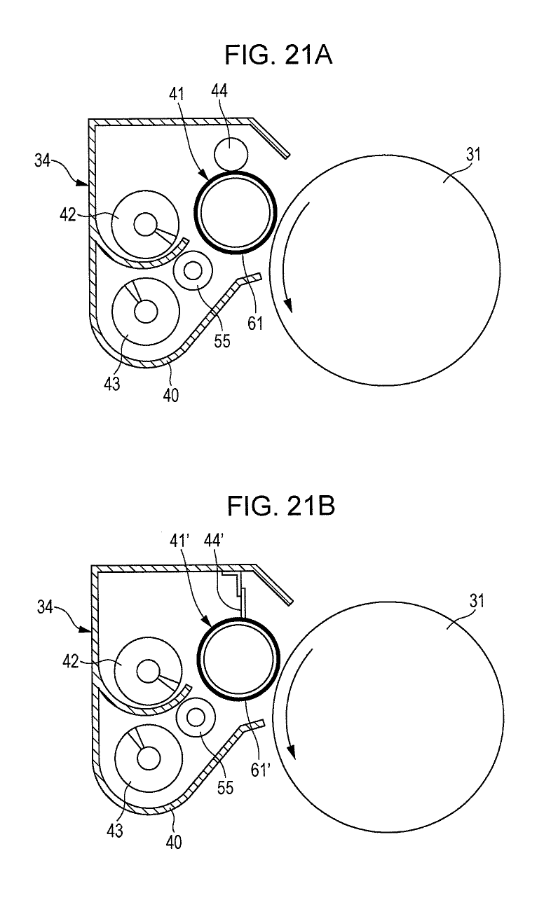

Example 1 is based on a configuration substantially the same as that described in the specific exemplary embodiment, except that, referring to FIG. 21A, the stirring/transporting members 42 and 43 included in the development device 34 are provided at upper and lower positions, respectively, and a roller 55 that collects unused developer G carried by the development roller 41 is additionally provided. The development roller 41 (including a smooth sleeve) and the layer regulating member (rotating trimmer) 44 are the same as those employed in the specific exemplary embodiment.

Comparative Example illustrated in FIG. 21B is based on a configuration similar to that employed in Example 1 but differs from Example 1 in that a development roller 41′ includes a development sleeve 61′ as a blast sleeve or a grooved sleeve and that a layer regulating member 44′ is a magnetic regulating member having a plate-like shape (a fixed trimmer).

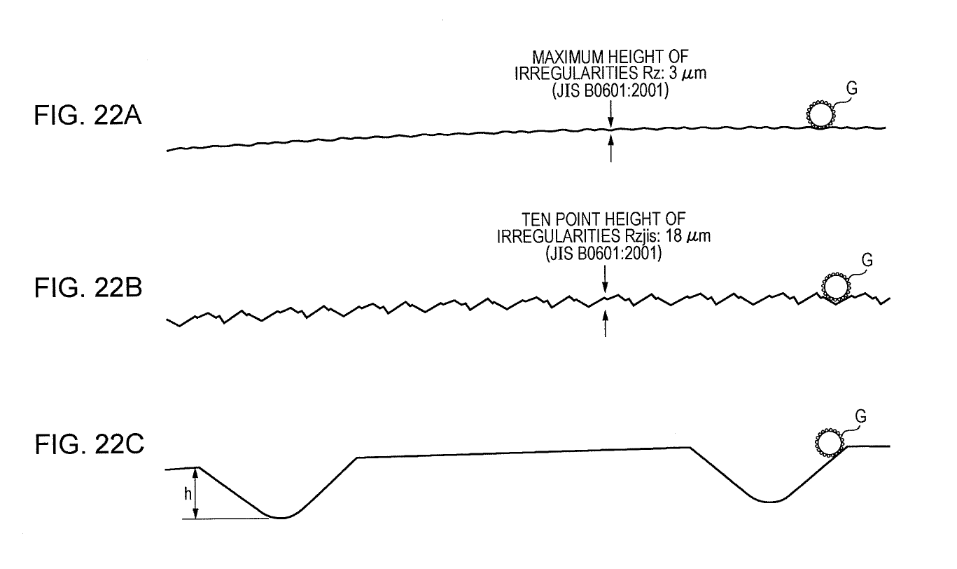

The development sleeve 61 according to Example 1 is a smooth sleeve (having a maximum height of surface irregularities Rz of 3 μm) illustrated in FIG. 22A.

The development sleeve 61′ according to Comparative Example (Comparative Examples 1 and 2) is a blast sleeve (the same smooth sleeve as that of Example 1 but having some particles blasted thereonto) illustrated in FIG. 22B or a grooved sleeve (the same smooth sleeve as that of Example 1 but having grooves) illustrated in FIG. 22C.

The gap between the layer regulating member and the development sleeve is set to 240 μl in both Example 1 and Comparative Example.

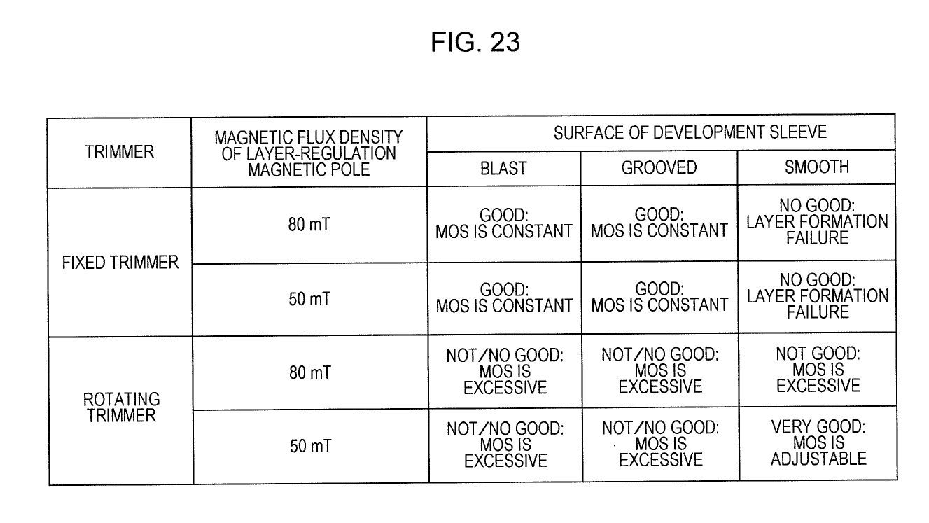

FIG. 23 summarizes the results of performance tests conducted for the development device 34 according to Example 1 and the development device 34 according to Comparative Example. In the tests, the amount of developer G (MOS) transported is measured under different conditions regarding the type of the layer regulating member (trimmer), the magnetic flux density of the layer-regulation magnetic pole, and the surface of the development sleeve.

Referring to the table illustrated in FIG. 23, in Comparative Example (Comparative Examples 1 or 2) in which a combination of a fixed trimmer and a blast sleeve or a grooved sleeve is employed, a constant amount of MOS is realized in a good manner, but it is difficult to adjust the amount of MOS.

In contrast, in Example 1 in which a combination of a rotating trimmer and a smooth sleeve is employed, the amount of MOS is adjustable in a very good manner.

When a combination of a smooth sleeve, as the development sleeve, and a fixed trimmer is employed, the formation of a layer of the developer G fails.

In a case where the magnetic flux density of the layer-regulation magnetic pole at the layer regulation site B is set to 50 mT, a proper, or not excessive, amount of MOS is realized. In contrast, in a case where the magnetic flux density of the layer-regulation magnetic pole is set to, for example, 80 mT, the amount of MOS tends to become high, although the formation of a layer of the developer G is possible.

That is, if the magnetic flux density of the layer-regulation magnetic pole at the layer regulation site B is set to 30 mT to 60 mT, the amount of MOS is easily adjustable to a proper value.

Example 1 includes Example 1-1 in which the gap between the layer regulating member 44 and the development sleeve 61 is set to 240 μm and Example 1-2 in which the foregoing gap is set to 70 μm. In addition, Example 2 in which a combination of a rotating trimmer and a blast sleeve is employed is implemented for reference.

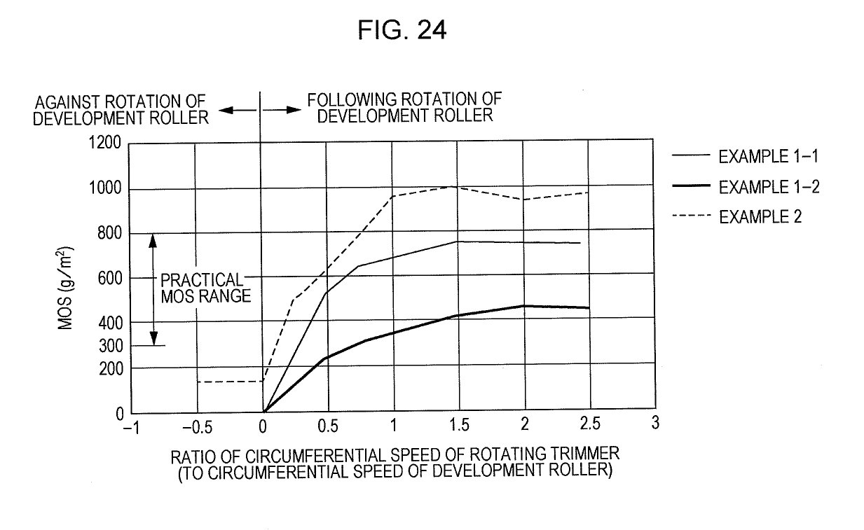

FIG. 24 is a graph illustrating the amount of MOS versus the circumferential speed ratio of the rotating trimmer for Examples 1-1, 1-2, and 2.

The practical range of MOS is about 300 to 800 g/m². In Example 1 (Examples 1-1 and 1-2), the circumferential speed ratio of the rotating trimmer over a wide range is variably adjusted within the practical range of MOS.

In contrast, in Example 2 in which a blast sleeve is employed, the amount of variation in the MOS relative to the circumferential speed ratio of the rotating trimmer is large, and the MOS exceeds the practical range at circumferential speed ratios of 0.7 and higher.

In Example 1 (Examples 1-1 and 1-2), the maximum height of irregularities of the smooth surface of the development sleeve 61 is set to 3 μm. When the above experiment is performed while the maximum height of irregularities of the smooth surface of the development sleeve 61 is varied, a tendency similar to that observed in Example 1 is observed in a range of maximum height of irregularities of 5 μm or less or about 5 μm or less.

Furthermore, when the above experiment is performed while the gap between the layer regulating member 44 and the development sleeve 61 is varied within a range from 0.035 mm to 1.5 mm (practical range), a tendency similar to that observed in Example 1 is observed. The operation is particularly stable in a range from about 0.060 to 1.0 mm.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A development device comprising:
a developer carrier that faces an image carrier capable of carrying an electrostatic latent image and is configured to rotate while carrying developer that contains at least toner and to develop the electrostatic latent image on the image carrier with the toner;
a layer-regulating rotating member that faces the developer carrier with a predetermined gap interposed therebetween and is configured to rotate in a direction that follows the rotation of the developer carrier in such a manner as to regulate the thickness of a layer of the developer on the developer carrier;
a development controller that controls, when development is performed, the developer carrier and the layer-regulating rotating member to rotate at respective predetermined circumferential speeds and supplies the developer on the developer carrier to the electrostatic latent image on the image carrier; and
a discharge controller that controls, at a certain time while development is stopped, the developer carrier to rotate at a predetermined circumferential speed while controlling the layer-regulating rotating member to rotate at a circumferential speed that changes intermittently such that the amount of developer passing the layer-regulating rotating member increases and decreases and any pieces of foreign matter and aggregates that are present in the developer are discharged together with the layer of the developer whose thickness is increased and decreased on the developer carrier.

2. The development device according to claim 1, wherein, when development is performed, the development controller variably adjusts the circumferential speed of the layer-regulating rotating member such that the circumferential speed of the layer-regulating rotating member changes with changes in a target thickness of the layer of the developer on the developer carrier to be realized through the regulation.

3. The development device according to claim 1, wherein, while development is stopped, the discharge controller controls the layer-regulating rotating member to rotate at a circumferential speed that changes intermittently between a driven period in which the layer-regulating rotating member is driven to rotate at a predetermined circumferential speed and a stopped period in which the layer-regulating rotating member is stopped.

4. The development device according to claim 2, wherein, while development is stopped, the discharge controller controls the layer-regulating rotating member to rotate at a circumferential speed that changes intermittently between a driven period in which the layer-regulating rotating member is driven to rotate at a predetermined circumferential speed and a stopped period in which the layer-regulating rotating member is stopped.

5. The development device according to claim 2, wherein, while development is stopped, the discharge controller controls the layer-regulating rotating member to rotate at a circumferential speed that changes intermittently between a predetermined first circumferential speed and a predetermined second circumferential speed different from the first circumferential speed.

6. A development device comprising:
a developer carrier that faces an image carrier capable of carrying an electrostatic latent image and is configured to rotate while carrying developer that contains at least a toner and to develop the electrostatic latent image on the image carrier with the toner;
a layer-regulating rotating member that faces the developer carrier with a predetermined gap interposed therebetween and is configured to rotate in a direction that follows the rotation of the developer carrier in such a manner as to regulate the thickness of a layer of the developer on the developer carrier;
a development controller that controls, when development is performed, the developer carrier and the layer-regulating rotating member to rotate at respective predetermined circumferential speeds and supplies the developer on the developer carrier to the electrostatic latent image on the image carrier; and
a discharge controller that controls, at a certain time while development is stopped, the developer carrier to rotate at a predetermined circumferential speed while controlling the layer-regulating rotating member such that the amount of developer passing the layer-regulating rotating member is increased from an amount of developer employed when development is performed and any pieces of foreign matter and aggregates that are present in the developer are discharged together with the layer of the developer whose thickness is increased on the developer carrier.

7. The development device according to claim 6,
wherein, when development is performed, the development controller variably adjusts the circumferential speed of the layer-regulating rotating member such that the circumferential speed of the layer-regulating rotating member changes with changes in a target thickness of the layer of the developer on the developer carrier to be realized through the regulation, and
wherein, at a certain time while development is stopped, the discharge controller controls the layer-regulating rotating member to rotate at a circumferential speed higher than the circumferential speed employed when development is performed.

8. The development device according to claim 6, wherein, while development is stopped, the discharge controller controls the developer carrier and the layer-regulating rotating member to rotate at respective predetermined circumferential speeds and produces an electric field between the developer carrier and the layer-regulating rotating member such that a surface of the layer-regulating rotating member attracts the toner.

9. The development device according to claim 7, wherein, while development is stopped, the discharge controller controls the developer carrier and the layer-regulating rotating member to rotate at respective predetermined circumferential speeds and produces an electric field between the developer carrier and the layer-regulating rotating member such that a surface of the layer-regulating rotating member attracts the toner.

10. The development device according to claim 1,
wherein the developer carrier includes
a rotating development member having a smooth surface with a maximum height of irregularities of about 5 μm or less; and
a magnetic member fixedly provided inside the rotating development member and having a plurality of magnetic poles provided on a circumference thereof, and
wherein, when the rotating development member is rotated, the rotating development member picks up the developer with the aid of a magnetic force produced by the magnetic poles of the magnetic member, the developer containing the toner and a carrier.

11. An image forming apparatus comprising:
an image carrier capable of carrying a toner image;
a latent-image-forming device configured to form an electrostatic latent image on the image carrier;
the development device according to claim 1 configured to develop the electrostatic latent image on the image carrier with a toner into a toner image;
a transfer device configured to transfer the toner image on the image carrier to a transfer medium; and
a cleaning device provided at a position, of the image carrier on a downstream side in a direction of rotation of the image carrier with respect to the transfer device and configured to clean off residues on the image carrier.

12. The image forming apparatus according to claim 11, further comprising a collection controller configured to control the latent-image-forming device, the development device, the image carrier, and the cleaning device, when the discharge controller discharges any pieces of foreign matter and aggregates in the developer together with the layer of the developer on the developer carrier, such that the pieces of foreign matter and aggregates discharged are collected in the cleaning device via the image carrier.

13. The image forming apparatus according to claim 12,
wherein the collection controller includes
a toner-band-latent-image-forming unit that causes, at a certain time while image formation is stopped, the latent-image-forming device to form on the image carrier a toner-band latent image developable with the toner and extending in a direction intersecting the direction of rotation of the image carrier;
a toner-band-forming unit that causes, at a certain time while development is stopped, the discharge controller to control the layer-regulating rotating member to operate such that the thickness of the layer of the developer is increased and decreased or is increased compared with the thickness employed when development is performed and such that the toner-band latent image on the image carrier is made to reach a development site defined in the development device when the layer of the developer whose thickness has been changed reaches the development site, the toner-band-forming unit further causing the development device to develop the toner-band latent image with the toner into a toner band under conditions conforming to conditions employed when development is performed; and
a toner-band-transporting unit that causes the toner band formed on the image carrier to be transported to the cleaning device while the transfer device is prevented from transferring the toner band to anywhere.

14. The image forming apparatus according to claim 12,
wherein the developer used in the development device contains the toner and a carrier,
wherein the collection controller includes
a carrier-band-latent-image-forming unit that causes, at a certain time while image formation is stopped, the latent-image-forming device to form on the image carrier a carrier-band latent image capable of attracting the carrier and extending in a direction intersecting the direction of rotation of the image carrier;
a carrier-band-forming unit that causes, at a certain time while development is stopped, the discharge controller to control the layer-regulating rotating member to operate such that the thickness of the layer of the developer is increased and decreased or is increased compared with the thickness employed when development is performed and such that the carrier-band latent image on the image carrier is made to reach a development site defined in the development device when the layer of the developer whose thickness has been changed reaches the development site, the carrier-band-forming unit further causing the development device to allow the carrier-band latent image to attract the carrier in such a manner as to form a carrier band under conditions that allow the attraction of the carrier but are different from conditions employed when development is performed; and
a carrier-band-transporting unit that causes the carrier band formed on the image carrier to be transported to the cleaning device while the transfer device is prevented from transferring the carrier band to anywhere.

15. The image forming apparatus according to claim 13,
wherein the developer used in the development device contains the toner and a carrier,
wherein the collection controller includes
a carrier-band-latent-image-forming unit that causes, at a certain time while image formation is stopped, the latent-image-forming device to form on the image carrier a carrier-band latent image capable of attracting the carrier and extending in a direction intersecting the direction of rotation of the image carrier;
a carrier-band-forming unit that causes, at a certain time while development is stopped, the discharge controller to control the layer-regulating rotating member to operate such that the thickness of the layer of the developer is increased and decreased or is increased compared with the thickness employed when development is performed and such that the carrier-band latent image on the image carrier is made to reach a development site defined in the development device when the layer of the developer whose thickness has been changed reaches the development site, the carrier-band-forming unit further causing the development device to allow the carrier-band latent image to attract the carrier in such a manner as to form a carrier band under conditions that allow the attraction of the carrier but are different from conditions employed when development is performed; and
a carrier-band-transporting unit that causes the carrier band formed on the image carrier to be transported to the cleaning device while the transfer device is prevented from transferring the carrier band to anywhere.

16. The image forming apparatus according to claim 13,
wherein the transfer device includes a transfer member that is pressed against the image carrier directly or with the transfer medium interposed therebetween, and
wherein, when the toner band passes through a transfer site, the transfer member is retracted from a position where the transfer member is pressed against the image carrier directly or with the transfer medium interposed therebetween such that the transfer member or the transfer medium goes out of contact with the toner band on the image carrier.

17. The image forming apparatus according to claim 14,
wherein the transfer device includes a transfer member that is pressed against the image carrier directly or with the transfer medium interposed therebetween, and
wherein, when the carrier band passes through a transfer site, the transfer member is retracted from a position where the transfer member is pressed against the image carrier directly or with the transfer medium interposed therebetween such that the transfer member or the transfer medium goes out of contact with the carrier band on the image carrier.

18. The image forming apparatus according to claim 11, wherein the discharge controller and the collection controller perform an operation of controlling the discharge of foreign matter and aggregates and an operation of controlling the collection of foreign matter and aggregates, respectively, for every predetermined number of times of image formation or every predetermined number of times of developer supply.

19. The image forming apparatus according to claim 11, further comprising a defect detector configured to detect any defects in the layer of the developer on the developer carrier or in the toner image on the image carrier or the transfer medium,
wherein the discharge controller and the collection controller perform an operation of controlling the discharge of foreign matter and aggregates and an operation of controlling the collection of foreign matter and aggregates, respectively, when the defect detector has detected any defects in the layer of the developer or in the toner image.
